(19) United States
(12) Patent Application Publication
(10) Pub. No.: US 2016/0034117 A1
(43) Pub. Date: Feb. 4, 2016

(54) ELECTRONIC DEVICE OPERATING IN IDLE MODE AND METHOD THEREOF

(71) Applicant: Samsung Electronics Co., Ltd., Suwon-si (KR)

(72) Inventors: Chang Jin KIM, Yongin-si (KR); Jung Tae KWON, Suwon-si (KR); Nam Yun KIM, Daegu (KR); Dong Sub KIM, Suwon-si (KR); Byeong Jae KIM, Dongducheon-si (KR)

(21) Appl. No.: 14/812,433

(22) Filed: Jul. 29, 2015

(30) Foreign Application Priority Data
Jul. 29, 2014 (KR) 10-2014-0096780

(51) Int. Cl. G06F 3/0482; G06F 3/0488; G06F 3/0484; G06F 3/041

(52) U.S. Cl. CPC G06F 3/0482; G06F 3/0416; G06F 3/04883; G06F 3/0484

(57) ABSTRACT

An electronic device is provided. The electronic device includes a touch screen module including at least one touch sensor and a display screen, a memory, and at least one processor electrically connected to the touch screen module and the memory. The touch screen module operates in at least one of a first state in which no input is received through the at least one touch sensor and no display screen operates, a second state in which an input is received using at least a portion of the at least one touch sensor and no display screen operates, or a third state in which all of the at least one touch sensor and all of the display screen operate. The second state switches to a fourth state in which a portion, but not all of the display screen is displayed, in response to a user input received using at least a portion of the at least one touch sensor at the second state.

### CROSS-REFERENCE TO RELATED APPLICATION(S)

This application claims the benefit under 35 U.S.C. §119(a) of a Korean patent application filed on Jul. 29, 2014 in the Korean Intellectual Property Office and assigned Serial number 10-2014-0096780, the entire disclosure of which is hereby incorporated by reference.

### TECHNICAL FIELD

The present disclosure relates to an electronic device and a method capable of receiving a user input in an idle mode. More particularly, the present disclosure relates to an electronic device and a method capable of directly executing a specific application or a specific function by inputting a certain pattern without a complicated procedure.

### BACKGROUND

With the development of information communication technologies, users may use electronic devices freely in motion. Such electronic devices may include, for example, a digital camera, a moving picture experts group (MPEG-1 or MPEG-2) audio layer 3 (MP3) player, a mobile phone, and the like.

A miniaturizing, lightweight and high-performance electronic device may cause a decrease in a battery capacity, and a complicated processor chip used in the electronic device may cause an increase in consumption of the battery.

To use a specific application, a user may release a lock state of an electronic device of the related art, search for an application icon of the specific application, and touch the found application icon. For example, the user may go through such a procedure to execute a desired application, thereby needing a lot of time. This may also occur in executing a specific function of a running application.

Therefore, a need exists for an electronic device and a method capable of directly executing a specific application or a specific function by inputting a certain pattern without a complicated procedure.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device and a method capable of directly executing a specific application or a specific function by inputting a certain pattern without a complicated procedure.

Another aspect of the present disclosure is to provide an electronic device and a method capable of providing an idle mode in which an input is received using at least a portion of a touch sensor at a state where a display screen does not operate.

In accordance with an aspect of the present disclosure, an electronic device is provided. The electronic device includes a touch screen module including at least one touch sensor and a display screen, a memory, and at least one processor electrically connected to the touch screen module and the memory. The touch screen module operates in at least one of a first state in which no input is received through the at least one touch sensor and no display screen operates, a second state in which an input is received using at least a portion of the at least one touch sensor and no display screen operates, or a third state in which all of the at least one touch sensor and all of the display screen operate. The second state switches to a fourth state in which a portion, but not all of the display screen is displayed, in response to a user input received using at least a portion of the at least one touch sensor at the second state.

In accordance with another aspect of the present disclosure, an electronic device is provided. The electronic device includes a touch screen module including at least one touch sensor and a display screen, a memory, and at least one processor electrically connected to the touch screen module and the memory. The touch screen module has one of a first state in which no input is received through the at least one touch sensor and no display screen operates, a second state in which an input is received using at least a portion of the at least one touch sensor and no display screen operates, or a third state in which all of the at least one touch sensor and all of the display screen operate. The touch screen module retains the second state or switch the second state to the third state, in response to a user input received using at least a portion of the at least one touch sensor at the second state.

In accordance with another aspect of the present disclosure, a method in which an electronic device receives an input using at least a portion of a touch sensor is provided. The method includes operating a touch screen module at a second state among states of a touch screen module including a first state in which no input is received through the touch sensor and no display screen operates, the second state in which an input is received using at least a portion of the touch sensor and no display screen operates, or a third state in which all of the touch sensor and all of the display screen operate, receiving a user input using at least a portion of the touch sensor at the second state, and switching the second state to a fourth state in which a portion, but not all of the display screen is displayed, in response to the user input.

In accordance with another aspect of the present disclosure, a computer-readable recording medium storing an instruction is provided. The instruction, when executed by at least one processor, causing the at least one processor to perform operating a touch screen module at a second state among states of a touch screen module includes a first state in which no input is received through the touch sensor and no display screen operates, a second state in which an input is received using at least a portion of the touch sensor and no display screen operates, or a third state in which all of the touch sensor and all of the display screen operate, receiving a user input using at least a portion of the touch sensor at the second state, and switching the second state to a fourth state in which a portion, but not all of the display screen is displayed, in response to the user input.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating an electronic device in a network environment according to various embodiments of the present disclosure;

FIG. 2 is a block diagram illustrating an electronic device according to various embodiments of the present disclosure;

FIG. 3 illustrates a block diagram of a program module according to various embodiments of the present disclosure;

FIG. 4 is a configuration diagram of an electronic device receiving a user input in an idle mode according to various embodiments of the present disclosure;

FIG. 5 is a diagram schematically illustrating a method in which a touch screen module detects a user input in an idle mode according to various embodiments of the present disclosure;

FIG. 6A is a diagram illustrating execution of a camera application based on a certain shape according to various embodiments of the present disclosure;

FIG. 6B is a diagram illustrating execution of a camera application based on a certain gesture according to various embodiments of the present disclosure;

FIG. 7 is a diagram illustrating an operation in which a menu icon is displayed according to a certain shape or gesture according to various embodiments of the present disclosure;

FIGS. 8A and 8B are diagrams illustrating a method for executing one icon of a displayed menu icon according to various embodiments of the present disclosure;

FIG. 9 is a diagram illustrating a method for displaying a sub menu icon on one icon of a displayed menu icon according to various embodiments of the present disclosure;

FIG. 10 is a diagram illustrating various methods for performing an operation corresponding to an instant message application according to various embodiments of the present disclosure;

FIG. 11 is a diagram illustrating a method for executing, in a dual screen mode, a certain operation based on a user input according to various embodiments of the present disclosure;

FIG. 12 is a diagram illustrating a method in which an electronic device including a plurality of touch screen panels performs a certain operation based on a user input according to various embodiments of the present disclosure;

FIG. 13 is a diagram illustrating a relationship between an electronic device and other electronic devices according to various embodiments of the present disclosure; and

FIG. 14 is a flowchart illustrating a method for receiving a user input using an idle mode according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

In various embodiments of the present disclosure, the expressions “have”, “may have”, “include” and “comprise”, or “may include” and “may comprise” used herein indicate existence of corresponding features (e.g., elements, such as numeric values, functions, operations, or components) but do not exclude presence of additional features.

In the disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used herein may refer to various elements of various embodiments of the present disclosure, but do not limit the elements. For example, such terms do not limit the order and/or priority of the elements. Furthermore, such terms may be used to distinguish one element from another element. For example, “a first user device” and “a second user device” indicate different user devices. For example, without departing the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), the element can be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used herein may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other components. For example, a “processor configured to perform A, B, and C” may mean a dedicated processor (e.g., an embedded processor) for performing a corresponding operation or a generic-purpose processor (e.g., a central processing unit (CPU) or an application processor (AP)) which may perform corresponding operations by executing one or more software programs which are stored in a memory device.

Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

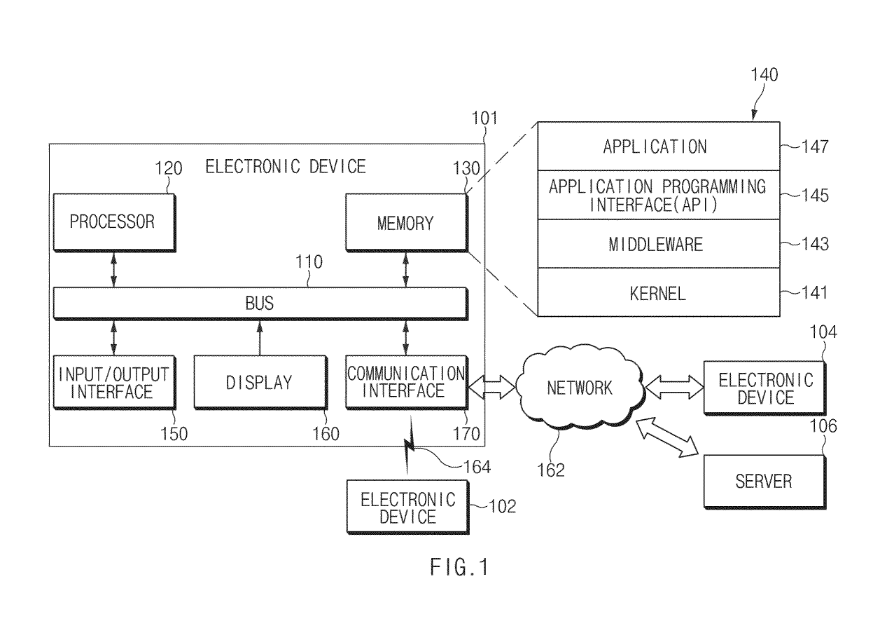

An electronic device according to various embodiments of the present disclosure may include a device, which receives a user input in an idle mode, to be described with reference to FIGS. 1 to 14. For example, the electronic devices may include at least one of smartphones, tablet personal computers (PCs), mobile phones, video telephones, electronic book readers, desktop PCs, laptop PCs, netbook computers, workstations, servers, personal digital assistants (PDAs), portable multimedia players (PMPs), a moving picture experts group (MPEG-1 or MPEG-2) audio layer 3 (MP3) players, mobile medical devices, cameras, wearable devices (e.g., head-mounted-devices (HMDs), such as electronic glasses), an electronic apparel, electronic bracelets, electronic necklaces, electronic appcessories, electronic tattoos, smart watches, and the like.

According to various embodiments of the present disclosure, the electronic devices may be smart home appliances receiving a user input in an idle mode. The smart home appliances may include at least one of, for example, televisions (TVs), digital versatile disc (DVD) players, audios, refrigerators, air conditioners, cleaners, ovens, microwave ovens, washing machines, air cleaners, set-top boxes, TV boxes (e.g., Samsung HomeSync™, Apple TV™, or Google TV™), game consoles (e.g., Xbox™ and PlayStation™), electronic dictionaries, electronic keys, camcorders, electronic picture frames, and the like.

According to various embodiments of the present disclosure, the electronic devices may include at least one of medical devices (e.g., various portable medical measurement devices (e.g., a blood glucose monitoring device, a heartbeat measuring device, a blood pressure measuring device, a body temperature measuring device, and the like)), a magnetic resonance angiography (MRA), a magnetic resonance imaging (MRI), a computed tomography (CT), scanners, and ultrasonic devices) receiving a user input in an idle mode, navigation devices, global positioning system (GPS) receivers, event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs), points of sales (POSs), or internet of things (e.g., light bulbs, various sensors, electric or gas meters, sprinkler devices, fire alarms, thermostats, street lamps, toasters, exercise equipment, hot water tanks, heaters, boilers, and the like).

According to various embodiments of the present disclosure, the electronic devices may include at least one of parts of furniture or buildings/structures, electronic boards, electronic signature receiving devices, projectors, or various measuring instruments (e.g., water meters, electricity meters, gas meters, or wave meters, and the like). The electronic devices according to various embodiments of the present disclosure may be one or more combinations of the above-mentioned devices.

According to various embodiments of the present disclosure, an electronic device may be a flexible electronic device receiving a user input in an idle mode.

In addition, electronic devices according to various embodiments of the present disclosure are not limited to the above-mentioned devices, and may include new electronic devices according to technology development.

Hereinafter, electronic devices according to various embodiments of the present disclosure will be described with reference to FIGS. 1 to 14. The term “user” used herein may refer to a person who uses an electronic device or may refer to a device (e.g., an artificial electronic device) that uses an electronic device.

FIG. 1 is a diagram illustrating an electronic device in a network environment according to various embodiments of the present disclosure.

Referring to FIG. 1, an electronic device 101 may include a bus 110, a processor 120, a memory 130, an input/output interface 150, a display 160, and a communication interface 170. According to various embodiments of the present disclosure, the electronic device 101 may not include at least one of the above-described components or may further include other component(s).

The bus 110 may interconnect the above-described components 110 to 170 and may be a circuit for conveying communications (e.g., a control message and/or data) among the above-described components.

The processor 120 may include one or more of a CPU, an AP, or a communication processor (CP). The processor 120 may perform, for example, data processing or an operation associated with control or communication of at least one other component(s) of the electronic device 101.

The memory 130 may include a volatile and/or nonvolatile memory. The memory 130 may store instructions or data associated with at least one other component(s) of the electronic device 101. According to various embodiments of the present disclosure, the memory 130 may store software and/or a program 140. The memory 130 may include, for example, a kernel 141, a middleware 143, an application programming interface (API) 145, and/or an application (or an application program) 147. At least a portion of the kernel 141, the middleware 143, or the API 145 may be called an “operating system (OS)”.

The kernel 141 may control or manage system resources (e.g., the bus 110, the processor 120, the memory 130, and the like) that are used to execute operations or functions of other programs (e.g., the middleware 143, the API 145, and the application program 147). Furthermore, the kernel 141 may provide an interface that allows the middleware 143, the API 145, or the application program 147 to access discrete components of the electronic device 101 so as to control or manage system resources.

The middleware 143 may perform a mediation role such that the API 145 or the application program 147 communicates with the kernel 141 to exchange data. Furthermore, with regard to task requests received from the application program 147, for example, the middle ware 143 may perform a control (e.g., scheduling or load balancing) on a task request using a method of assigning the priority, which makes it possible to use a system resource (e.g., the bus 110, the processor 120, the memory 130, or the like) of the electronic device 101, to at least one application.

The API 145 may be an interface through which the application program 147 controls a function provided by the kernel 141 or the middleware 143, and may include, for example, at least one interface or function (e.g., an instruction) for a file control, a window control, image processing, a character control, or the like.

The input/output (I/O) interface 150 may transmit an instruction or data, input from a user or another external device, to other component(s) of the electronic device 101. Furthermore, the I/O interface 150 may output an instruction or data, received from other component(s) of the electronic device 101, to a user or another external device.

The display 160 may include, for example, a liquid crystal display (LCD), a light-emitting diode (LED) display, an organic LED (OLED) display, or a microelectromechanical systems (MEMS) display, or an electronic paper display. The display 160 may display, for example, various contents (e.g., a text, an image, a video, an icon, a symbol, and the like) to a user. The display 160 may include a touch screen and may receive, for example, a touch, gesture, proximity, or hovering input using an electronic pen or a portion of a user's body.

The communication interface 170 may establish communication between the electronic device 101 and an external electronic device (e.g., a first external electronic device 102, a second external electronic device 104, or a server 106). For example, the communication interface 170 may be connected to a network 162 through wireless communication 164 or wired communication to communicate with the external device (e.g., the second external electronic device 104 or the server 106).

The wireless communication may include at least one of, for example, long term evolution (LTE), LTE-advanced (LTE-A), code division multiple access (CDMA), wideband CDMA (WCDMA), universal mobile telephone system (UMTS), wireless broadband (WiBro), global system for mobile communications (GSM), or the like, as cellular communication protocol. The wired communication may include at least one of, for example, a universal serial bus (USB), a high definition multimedia interface (HDMI), a recommended standard-232 (RS-232), or a plain old telephone service (POTS). The network 162 may include at least one of telecommunications networks, for example, a computer network (e.g., local area network (LAN) or wide area network (WAN)), an internet, or a telephone network.

Each of the first external electronic device 102 and the second external electronic device 104 may be a device of which the type is different from or the same as that of the electronic device 101. According to an embodiment of the present disclosure, the server 106 may include a group of one or more servers. According to various embodiments of the present disclosure, all or a part of operations that the electronic device 101 will perform may be executed by another or plural electronic devices (e.g., the first external electronic device 102 and the second external electronic device 104 and the server 106). According to an embodiment of the present disclosure, when the electronic device 101 executes any function or service automatically or in response to a request, the electronic device 101 may not perform the function or the service internally, but, alternatively additionally, the electronic device 101 may request at least a portion of a function associated with the electronic device 101 be performed at the other device (e.g., the first external electronic device 102 or the second external electronic device 104 or the server 106). The other electronic device (e.g., the first external electronic device 102 or the second external electronic device 104 or the server 106) may execute the requested function or additional function and may transmit the execution result to the electronic device 101. The electronic device 101 may provide the requested function or service using the received result or may additionally process the received result to provide the requested function or service. To this end, for example, cloud computing, distributed computing, or client-server computing may be used.

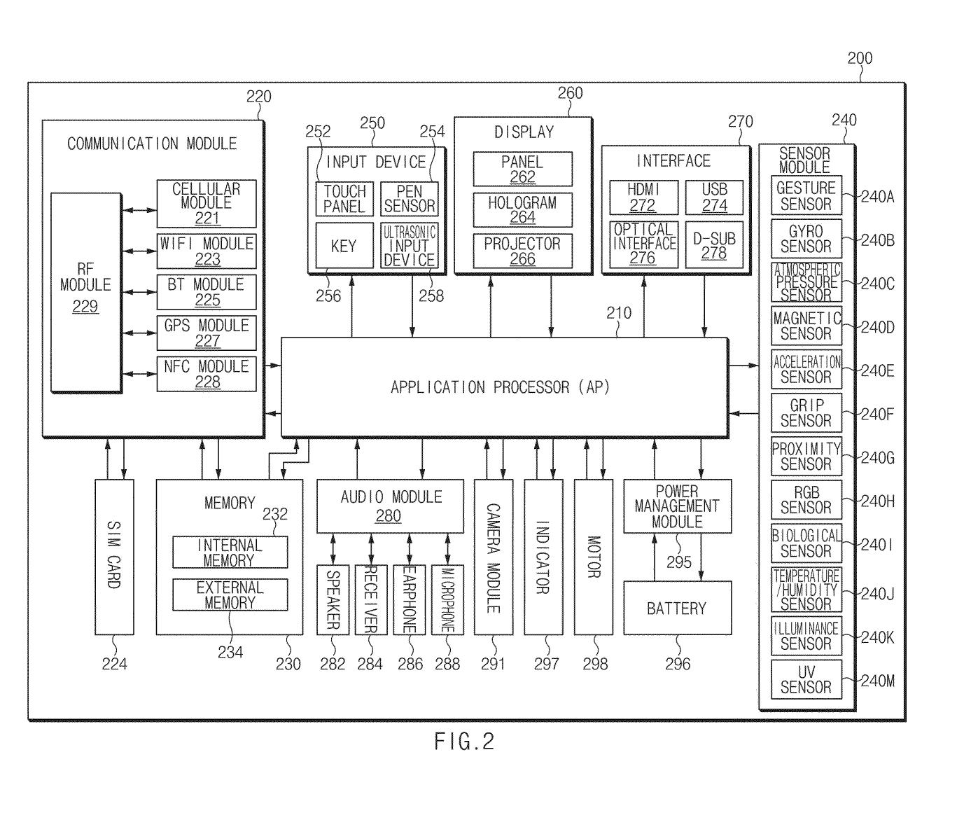

FIG. 2 is a block diagram illustrating an electronic device according to various embodiments of the present disclosure.

Referring to FIG. 2, an electronic device 200 may include all or a part of an electronic device 101 illustrated in FIG. 1. The electronic device 200 may include one or more APs 210, a communication module 220, a subscriber identification module (SIM) card 224, a memory 230, a sensor module 240, an input device 250, a display 260, an interface 270, an audio module 280, a camera module 291, a power management module 295, a battery 296, an indicator 297, and a motor 298.

The AP 210 may drive, for example, an OS or an application to control a plurality of hardware or software components connected to the AP 210 and may process and compute a variety of data including multimedia data. The AP 210 may be implemented with a System on Chip (SoC), for example. According to an embodiment of the present disclosure, the AP 210 may further include a graphical processing unit (GPU) (not illustrated) and/or an image signal processor (ISP). The communication module 220 may include a part (e.g., a cellular module 221) of components illustrated in FIG. 2. The AP 210 may load instructions or data, received from at least one of other components (e.g., a nonvolatile memory), onto a volatile memory and may store various data at a nonvolatile memory.

The communication module 220 may be configured to be the same as or similar to a communication interface 170 illustrated in FIG. 1. The communication module 220 may include a cellular module 221, a wireless-fidelity (Wi-Fi) module 223, a bluetooth (BT) module 225, a GPS module 227, a near field communication (NFC) module 228, and a radio frequency (RF) module 229.

The cellular module 221 may provide voice communication, video communication, a character service, an Internet service, and the like through a communication network. According to an embodiment of the present disclosure, the cellular module 221 may perform discrimination and authentication of an electronic device within a communication network using a SIM (e.g., the SIM card 224), for example. According to an embodiment of the present disclosure, the cellular module 221 may perform at least a portion of functions that the AP 210 provides. According to an embodiment of the present disclosure, the cellular module 221 may include a CP.

Each of the Wi-Fi module 223, the BT module 225, the GPS module 227, and the NFC module 228 may include a processor for processing data exchanged through a corresponding module, for example. According to various embodiments of the present disclosure, at least a portion (e.g., two or more components) of the cellular module 221, the Wi-Fi module 223, the BT module 225, the GPS module 227, and the NFC module 228 may be included within one integrated circuit (IC) or an IC package.

The RF module 229 may transmit and receive data, for example, a communication signal (e.g., an RF signal). The RF module 229 may include a transceiver, a power amplifier module (PAM), a frequency filter, low noise amplifier (LNA), an antenna, or the like. According to various embodiments of the present disclosure, at least one of the cellular module 221, the Wi-Fi module 223, the BT module 225, the GPS module 227, or the NFC module 228 may transmit and receive an RF signal through a separate RF module.

The SIM card 224 may include, for example, a card and/or embedded SIM that includes a SIM and may include unique identify information (e.g., integrated circuit card identifier (ICCID)) or subscriber information (e.g., integrated mobile subscriber identity (IMSI)).

The memory 230 (e.g., the memory 130) may include an embedded memory 232 or an external memory 234. For example, the embedded memory 232 may include at least one of a volatile memory (e.g., a dynamic random access memory (DRAM), a static RAM (SRAM), or a synchronous DRAM (SDRAM)), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a not and (NAND) flash memory, or a not or (NOR) flash memory), a hard drive, or a solid state drive (SSD).

The external memory 234 may include a flash drive, for example, compact flash (CF), secure digital (SD), micro-SD, mini-SD, extreme digital (xD) or a memory stick. The external memory 234 may be functionally and/or physically connected to the electronic device 200 through various interfaces.

The sensor module 240 may measure a physical quantity or may detect an operation state of the electronic device 200. The sensor module 240 may convert the measured or detected information to an electric signal. Generally or additionally, the sensor module 240 may include at least one of a gesture sensor 240A, a gyro sensor 240B, a pressure sensor 240C, a magnetic sensor 240D, an acceleration sensor 240E, a grip sensor 240F, a proximity sensor 240G, a color sensor 240H (e.g., red, green, blue (RGB) sensor), a living body sensor 240I, a temperature/humidity sensor 240J, an illuminance sensor 240K, or an ultraviolet (UV) sensor 240M. Although not illustrated, additionally or generally, the sensor module 240 may further include, for example, an E-nose sensor, an electromyography sensor (EMG) sensor, an electroencephalogram (EEG) sensor, an electrocardiogram (ECG) sensor, a photoplethysmographic (PPG) sensor, an infrared (IR) sensor, an iris sensor, a fingerprint sensor, and the like. The sensor module 240 may further include a control circuit for controlling at least one or more sensors included therein. According to various embodiments of the present disclosure, the electronic device 200 may further include a processor which is a part of the AP 210 or independent of the AP 210 and is configured to control the sensor module 240. The processor may control the sensor module 240 when the AP 210 remains at a sleep state.

The input device 250 may include a touch panel 252, a (digital) pen sensor 254, a key 256, or an ultrasonic input unit 258. The touch panel 252 may use at least one of capacitive, resistive, IR and ultrasonic detecting methods. In addition, the touch panel 252 may further include a control circuit. The touch panel 252 may further include a tactile layer. In this case, the touch panel 252 may provide a tactile reaction to a user.

The (digital) pen sensor 254 may be a part of a touch panel or may include a separate sheet for recognition. The key 256 may include, for example, a physical button, an optical key, a keypad, and the like. The ultrasonic input device 258, which is an input device for generating an ultrasonic signal, may enable the electronic device 200 to detect a sound wave through a microphone (e.g., a microphone 288) so as to identify data.

The display 260 (e.g., the display 160) may include a panel 262, a hologram device 264, or a projector 266. The panel 262 may be configured to be the same as or similar to a display 160 illustrated in FIG. 1. The panel 262 may be, for example, flexible, transparent or wearable. The panel 262 and the touch panel 252 may be integrated into a single module. The hologram device 264 may display a stereoscopic image in a space using a light interference phenomenon. The projector 266 may project light onto a screen so as to display an image. The screen may be arranged in the inside or the outside of the electronic device 200. According to an embodiment of the present disclosure, the display 260 may further include a control circuit for controlling the panel 262, the hologram device 264, or the projector 266.

The interface 270 may include, for example, an HDMI 272, an USB 274, an optical interface 276, or a D-subminiature (D-sub) 278. The interface 270 may be included, for example, in a communication interface 170 illustrated in FIG. 1. Additionally or generally, the interface 270 may include, for example, a mobile high definition link (MHL) interface, an SD card/multi-media card (MMC) interface, or an infrared data association (IrDA) standard interface.

The audio module 280 may convert a sound and an electric signal in dual directions. At least a portion of the audio module 280 may be included, for example, in an input/output interface 150 illustrated in FIG. 1. The audio module 280 may process, for example, sound information that is input or output through a speaker 282, a receiver 284, an earphone 286, or the microphone 288.

The camera module 291 for shooting a still image or a video may include, for example, at least one image sensor (e.g., a front sensor or a rear sensor), a lens (not illustrated), an ISP (not illustrated), or a flash (e.g., an LED or a xenon lamp, not illustrated).

The power management module 295 may manage, for example, power of the electronic device 200. According to an embodiment of the present disclosure, a power management IC (PMIC) a charger IC, or a battery or fuel gauge may be included in the power management module 295. The PMIC may have a wired charging method and/or a wireless charging method. The wireless charging method may include, for example, a magnetic resonance method, a magnetic induction method or an electromagnetic method, and may further include a coil loop, a resonant circuit, a rectifier, and the like. The battery gauge may measure, for example, a remaining capacity of the battery 296 and a voltage, current or temperature thereof while the battery is charged. The battery 296 may include, for example, a rechargeable battery or a solar battery.

The indicator 297 may display a specific state of the electronic device 200 or a part thereof (e.g., the AP 210), such as a booting state, a message state, a charging state, and the like. The motor 298 may convert an electrical signal into a mechanical vibration and may generate vibration or a haptic effect. Although not illustrated, a processing device (e.g., a GPU) for supporting a mobile TV may be included in the electronic device. The processing device for supporting a mobile TV may process media data according to the standards of digital multimedia broadcasting (DMB), digital video broadcasting (DVB) or media flow.

Each of the above-mentioned elements of the electronic device according to various embodiments of the present disclosure may be configured with one or more components, and the names of the elements may be changed according to the type of the electronic device. The electronic device according to various embodiments of the present disclosure may include at least one of the above-mentioned elements, and some elements may be omitted or other additional elements may be added. Furthermore, some of the elements of the electronic device according to various embodiments of the present disclosure may be combined with each other so as to form one entity, so that the functions of the elements may be performed in the same manner as before the combination.

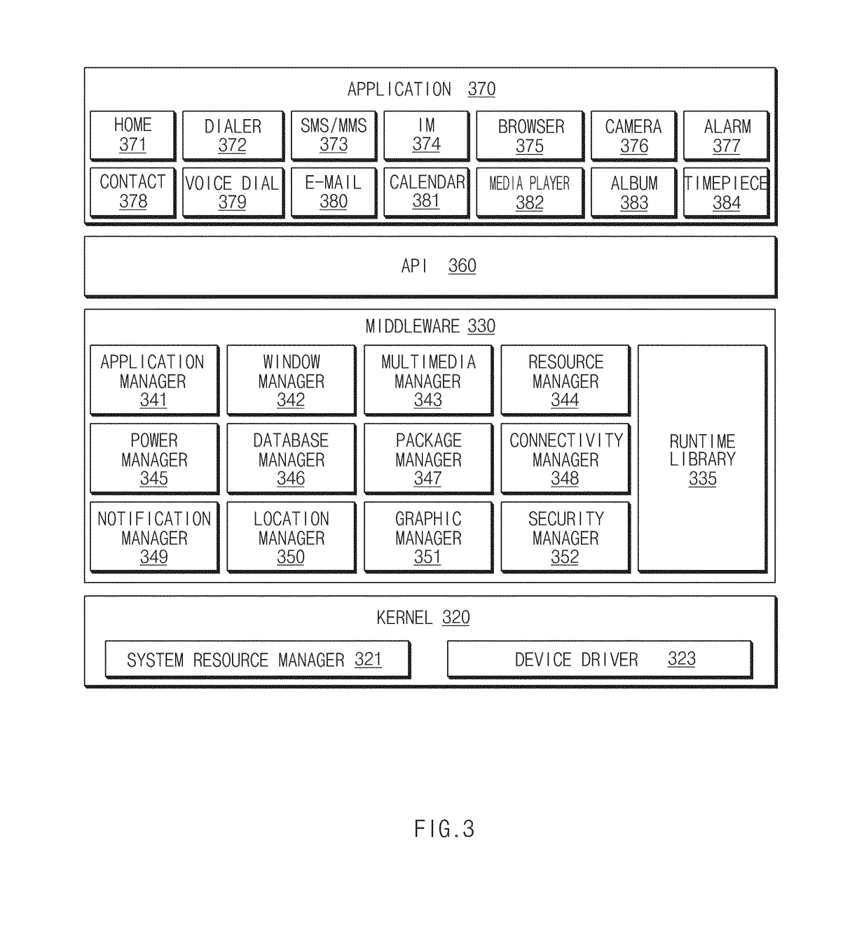

FIG. 3 illustrates a block diagram of a program module according to various embodiments of the present disclosure.

Referring to FIG. 3, according to an embodiment of the present disclosure, a program module 310 (e.g., the program 140) may include an OS to control resources relevant to an electronic device (e.g., the electronic device 101), and/or diverse applications (e.g., the application program 147) driven on the OS. The OS may be, for example, android, iOS, windows, symbian, tizen, or bada.

The program module 310 may include a kernel 320, a middleware 330, an API 360, and/or an application 370. At least a part of the program module 310 may be preloaded on an electronic device or may be downloadable from a server (e.g., the server 106).

The kernel 320 (e.g., the kernel 141 of FIG. 1) may include, for example, a system resource manager 321 or a device driver 323. The system resource manager 321 may perform control, allocation, or retrieval of system resources. According to an embodiment of the present disclosure, the system resource manager 321 may include a process managing part, a memory managing part, or a file system managing part. The device driver 323 may include, for example, a display driver, a camera driver, a BT driver, a common memory driver, an USB driver, a keypad driver, a Wi-Fi driver, an audio driver, or an inter-process communication (IPC) driver.

The middleware 330 may provide, for example, a function which the application 370 needs in common, or may provide diverse functions to the application 370 through the API 360 to allow the application 370 to efficiently use limited system resources of the electronic device. According to an embodiment of the present disclosure, the middleware 330 (e.g., the middleware 143) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, or a security manager 352.

The runtime library 335 may include, for example, a library module which is used by a compiler to add a new function through a programming language while the application 370 is being executed. The runtime library 335 may perform input/output management, memory management, or capacities about arithmetic functions.

The application manager 341 may manage, for example, a life cycle of at least one application of the application 370. The window manager 342 may manage a graphical user interface (GUI) resource which is used in a screen. The multimedia manager 343 may identify a format necessary for playing diverse media files, and may perform encoding or decoding of media files by using a codec suitable for the format. The resource manager 344 may manage resources, such as a storage space, a memory, or a source code of at least one application of the application 370.

The power manager 345 may operate, for example, with a basic I/O system (BIOS) to manage a battery or power, and may provide power information for an operation of an electronic device. The database manager 346 may generate, search for, or modify database which is to be used in at least one application of the application 370. The package manager 347 may install or update an application which is distributed in the form of package file.

The connectivity manager 348 may manage, for example, a wireless connection, such as Wi-Fi or BT. The notification manager 349 may display or notify an event, such as an arrival message, a promise, or a proximity notification in a mode that does not disturb a user. The location manager 350 may manage location information of an electronic device. The graphic manager 351 may manage a graphic effect that is provided to a user, or manage a user interface (UI) relevant thereto. The security manager 352 may provide a general security function necessary for system security or user authentication. According to an embodiment of the present disclosure, when an electronic device (e.g., the electronic device 101) includes a telephony function, the middleware 330 may further includes a telephony manager for managing a voice or video call function of the electronic device.

The middleware 330 may include a middleware module that combines diverse functions of the above-described components. The middleware 330 may provide a module specialized to each OS kind to provide differentiated functions. Additionally, the middleware 330 may remove a part of the preexisting components, dynamically, or may add a new component thereto.

The API 360 (e.g., the API 145) may be, for example, a set of programming functions and may be provided with a configuration which is variable depending on an OS. For example, when an OS is the android or the iOS, it may be permissible to provide one API set per platform. When an OS is the tizen, it may be permissible to provide two or more API sets per platform.

The application 370 (e.g., the application program 147) may include, for example, one or more applications capable of providing functions for a home 371, a dialer 372, a short message service (SMS)/multimedia messaging service (MMS) 373, an instant message (IM) 374, a browser 375, a camera 376, an alarm 377, a contact 378, a voice dial 379, an e-mail 380, a calendar 381, a media player 382, an album 383, and a timepiece 384, or for offering health care (e.g., measuring an exercise quantity or blood sugar) or environment information (e.g., atmospheric pressure, humidity, or temperature).

According to an embodiment of the present disclosure, the application 370 may include an application (hereinafter referred to as “information exchanging application” for descriptive convenience) to support information exchange between the electronic device (e.g., the electronic device 101) and an external electronic device (e.g., the first external electronic device 102 or the second external electronic device 104). The information exchanging application may include, for example, a notification relay application for transmitting specific information to the external electronic device, or a device management application for managing the external electronic device.

For example, the information exchanging application may include a function of transmitting notification information, which arise from other applications (e.g., applications for SMS/MMS, e-mail, health care, or environmental information), to an external electronic device (e.g., the first external electronic device 102 or the second external electronic device 104). Additionally, the information exchanging application may receive, for example, notification information from an external electronic device and provide the notification information to a user. The device management application may manage (e.g., install, delete, or update), for example, at least one function (e.g., turn-on/turn-off of an external electronic device itself (or a part of components) or adjustment of brightness (or resolution) of a display) of the external electronic device (e.g., the second external electronic device 104) which communicates with the electronic device, an application running in the external electronic device, or a service (e.g., a call service or a message service) provided from the external electronic device.

According to an embodiment of the present disclosure, the application 370 may include an application (e.g., a health care application) which is assigned in accordance with an attribute (e.g., an attribute of a mobile medical device as a kind of electronic device) of the external electronic device (e.g., the first external electronic device 102 or the second external electronic device 104). According to an embodiment of the present disclosure, the application 370 may include an application which is received from an external electronic device (e.g., the server 106 or the first external electronic device 102 or the second external electronic device 104). According to an embodiment of the present disclosure, the application 370 may include a preloaded application or a third party application which is downloadable from a server. The component titles of the program module 310 according to the embodiment of the present disclosure may be modifiable depending on kinds of OSs.

According to various embodiments of the present disclosure, at least a part of the program module 310 may be implemented in software, firmware, hardware, or a combination of at least two or more combinations thereof. At least a part of the program module 310 may be implemented (e.g., executed), for example, by a processor (e.g., the AP 210). At least a part of the program module 310 may include, for example, a module, a protein, a set of instructions, or a process for performing one or more functions.

A physical button of an electronic device may gradually disappear, and a role thereof may be performed using a touch screen panel. Furthermore, in the case of a portable electronic device, it may be important to reduce a bezel area and to make secure of a battery capacity through efficient internal space arrangement within a restricted housing. Additionally, the recent trend may be to improve battery use efficiency of an electronic device and efficiency of a battery itself as well as to secure a battery capacity.

According to various embodiments of the present disclosure, in an idle mode where an electronic device operates with low power, an electronic device may receive a user input through a touch screen panel and may perform a certain operation by activating a processor based on the user input thus received.

For example, various embodiments of the present disclosure may reduce power consumption through a practical operation of the electronic device and may control the electronic device with low power using a touch screen panel, not a physical button.

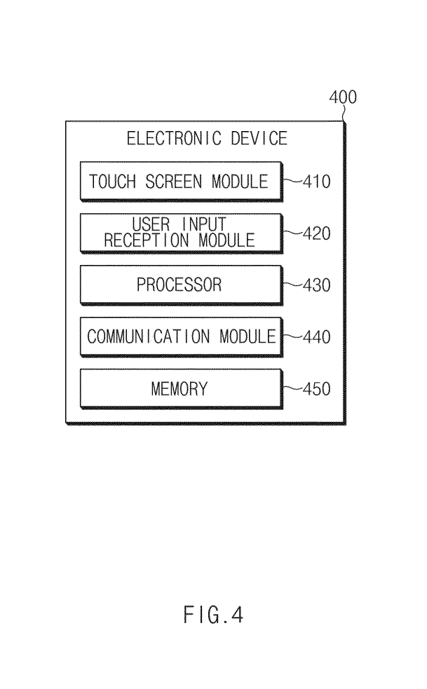

FIG. 4 is a configuration diagram of an electronic device receiving a user input in an idle mode according to various embodiments of the present disclosure.

Referring to FIG. 4, an electronic device 400 may include a touch screen panel (TSP) module 410, a user input receiving module 420, a processor 430, a communication module 440, and a memory 450. The electronic device 400 illustrated in FIG. 4 may be exemplary, and modification or change on the electronic device 400 may be variously made based on components illustrated in FIG. 4. For example, the electronic device 400 may further include UIs, such as a keyboard, a mouse, and the like, to receive instructions or information from a user.

The touch screen module 410 may include at least one touch sensor and a display screen. The at least one touch sensor and display screen may be provided at the electronic device 400 as a touch screen panel. For example, the touch screen module 410 may include a component(s) that is at least the same as or similar to a display 160 illustrated in FIG. 1.

The touch screen module 410 may implement an idle mode. The idle mode may be a mode in which a touch input on a touch screen panel is detected at an off state of a display including a LCD or an active matrix organic LED (AMOLED). The idle mode may be, for example, a mode including the case that an application is running at a background. Furthermore, in the idle mode, the touch screen module 410 may detect the touch input without involvement of the touch screen module 410. Accordingly, in comparison with an active mode, the idle mode may make it possible to detect a touch input and to reduce power consumption. Below, it may be assumed that a touch input is a user input.

In addition, the touch screen module 410 may use at least a portion of a plurality of Rx lines and a plurality of Tx lines of the touch screen panel in the idle mode, thereby reducing power consumption.

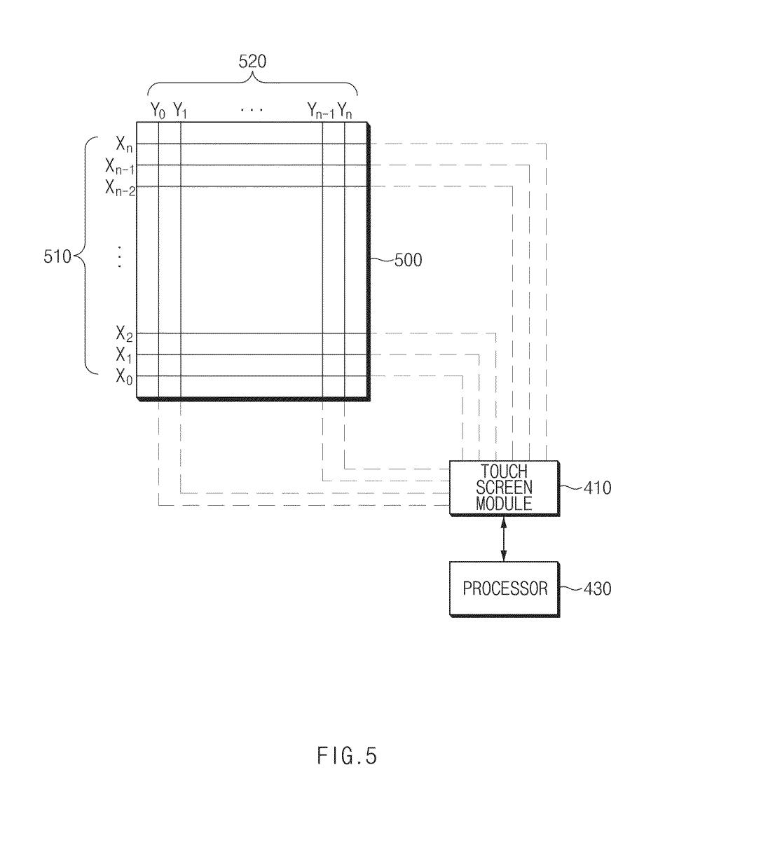

Below, an idle mode of operation of the touch screen module 410 will be more fully described with reference to FIG. 5.

FIG. 5 is a diagram schematically illustrating a method in which a touch screen module detects a user input in an idle mode according to various embodiments of the present disclosure.

Referring to FIG. 5, a touch screen panel 500 may include Tx lines 510 including X₀ to Xₙ lines and Rx lines 520 including Y₀ to Yₙ lines. The Tx lines and the Rx lines may be interchangeable. For example, the X₀ to Xₙ lines may constitute the Rx lines, and the Y₀ to Yₙ lines may constitute the Tx lines.

A touch screen module 410 may use at least a portion of a plurality of Tx lines 510 and a plurality of Rx lines 520 to allow a user input receiving module 420 to receive the user input. Here, the user input receiving module 420 may be a component included in the touch screen module 410. Alternatively, the user input receiving module 420 may correspond, for example, to a configuration of at least a portion included in an input/output interface 150 illustrated in FIG. 1. The touch screen module 410 may simply use, for example, the X₀ to Xₙ lines or the Y₀ to Yₙ lines. Furthermore, the touch screen module 410 may simply use a portion (e.g., odd-numbered Tx lines or even-numbered Tx lines) of the X₀ to Xₙ lines or a portion (e.g., odd-numbered Rx lines or even-numbered Rx lines) of the Y₀ to Yₙ lines. For example, in the idle mode, the touch screen module 410 may detect the user input using the Tx line set including all or a portion of the plurality of Tx lines 510 or an Rx line set including all or a portion of the plurality of Rx lines 520. Unlike the above description, the touch screen module 410 may use a portion of the Tx lines 510 and a portion of the Rx lines 520 together.

If receiving a user input from the user input receiving module 420, the touch screen module 410 may wake up a processor 430. The processor 430 may include, for example, a configuration that is at least the same as or similar to a processor illustrated in FIG. 1. As described above, the touch screen module 410 may detect the user input without the processor 430. Since the processor 430 determines whether the user input is a pattern previously stored at a memory 450, the touch screen module 410 may request the processor 430 to determine a pattern of the user input based on the user input thus received. The processor 430 may determine a pattern in an active mode. For example, the processor 430 may change the idle mode to the active mode based on the user input.

According to various embodiments of the present disclosure, the touch screen panel 500 may be of a self-capacitance manner. The self-capacitance manner may have the disadvantage that there is generated a ghost image problem in which an after-image remains and bleeds on a display with respect to a multi-user input (multi-touch input), but may have the advantage that power consumption is reduced as compared with a mutual-capacitance manner. Accordingly, the self-capacitance manner may be suitable for the idle mode. Since a pattern of the user input is determined in the active mode and the user input is a multi-user input, the touch screen panel 500 of the mutual-capacitance manner may be used in the active mode. For example, the electronic device 400 may include both the touch screen panel 500 of the self-capacitance manner and the touch screen panel 500 of the mutual-capacitance manner, and may use the touch screen panels 500 having different manners in turn as occasion demands.

Referring to FIG. 4, the touch screen module 410 itself may determine whether to use at least a portion of the Tx lines 510 and the Rx lines 520, but such an operation may be controlled by the processor 430.

Furthermore, to reduce power consumption, the touch screen module 410 may adjust at least one or more of a response time of the touch screen panel 500, a reference determining time, a voltage level of the Tx line 510 or the Rx line 520, a core operation of a noise filter, or an operation clock of a TSP IC. The adjusting operation of the touch screen module 410 may be executed in response to an instruction from the processor 430.

According to various embodiments of the present disclosure, the response time may be changed from 90 Hz to 10 to 30 Hz, and the reference determining time may be changed from 1 second to 2 seconds. Furthermore, the core operation of the noise filter may be changed from 4 ms to 2.7 ms, and the voltage level of the Tx line 510 or the Rx line 520 may be changed from 12 V to 6 V. In addition, the operation clock of the TSP IC may be changed from 48 MHz to 6 MHz.

Prior to describing current consumption of an electronic device 400 due to a variation in the response time, there will be described various modes of the electronic device 400. The modes may be classified into a normal mode and a low power mode. One of factors for distinguishing the normal mode and the low power mode may be the response time. The normal mode may operate at 90 Hz, and the low power mode may operate at 10 Hz, 20 Hz, or 30 Hz.

The low power mode may include the above-described idle and active modes. For example, the idle mode and the active mode described with reference to FIGS. 4 and 5 may be a low-power idle mode and a low-power active mode operating at 10 Hz, 20 Hz, or 30 Hz. A current less than 0.5 mA may be consumed when the low-power active mode operates at 10 Hz, a current less than 1.0 mA may be consumed when the low-power active mode operates in 20 Hz, and a current less than 1.5 mA may be consumed when the low-power active mode operates at 30 Hz. In contrast, a current less than 0.15 mA may be consumed when the low-power idle mode operates at 10 Hz, a current less than 0.3 mA may be consumed when the low-power idle mode operates at 20 Hz, and a current less than 0.5 mA may be consumed when the low-power idle mode operates at 30 Hz.

The low power mode may further include a detect mode for defining a user input from occurrence to touch release, when an user input received in the idle mode is not a certain pattern (e.g., a certain shape or gesture). However, no difference between the detect mode and the low-power idle mode may exist in terms of current consumption, and thus, a detailed description thereof may be omitted.

The normal mode may operate at 90 Hz. If the active mode operates at 90 Hz, a current of 20 mA may be consumed. If the idle mode operates at 90 Hz, a current less than 3 mA may be consumed. For example, in the idle mode, current consumption when the response time is 10 Hz may be reduced up to a maximum of 1/20 of current consumption when the response time is 90 Hz. Similarly, in the active mode, current consumption when the response time is 10 Hz may be reduced up to a maximum of 1/40 of current consumption when the response time is 90 Hz.

An electronic device of the related art may consume a current in the low-power idle mode as much as 1.51 mA (operating at 16 Hz) and may consume a current in the low-power active mode as much as 10.31 mA (operating at 60 Hz). Furthermore, the electronic device of the related art may consume a current in the low-power detect mode as much as 2.98 mA (operating at 16 Hz). The electronic device of the related art may be much more different from the electronic device 400 in terms of current consumption. Furthermore, the electronic device of the related art may consume a current of 30 mA in a normal active mode and a current of 4 mA in a normal idle mode. It may be comprehended that current consumption of the electronic device 400 according to various embodiments of the present disclosure is markedly reduced in the normal mode.

Unless specifically mentioned, an idle mode and an active mode above described or to be described later may mean a low-power idle mode and a low-power active mode, respectively.

A user input receiving module 420 may receive a user input through the touch screen panel 500 in the idle mode. For example, the user input receiving module 420 may receive as a user input a touch input that the touch screen module 410 detects. In this case, as described above, at least a portion of Rx and Tx lines of the touch screen panel 500 may be used to allow the touch screen module 410 to detect the touch input.

The user input receiving module 420 may be a sensor (or a controller) included in the touch screen panel 500. The touch screen panel 500 may be a resistive touch panel. In this case, the user input receiving module 420 may be a resistive sensor included in the touch screen panel 500. Furthermore, the user input receiving module 420 may be one module included in the touch screen module 410.

As described above, the processor 430 may change the idle mode to the active mode. The conversion of a mode may be performed based on a mode conversion request from the touch screen module 410. In this case, the mode conversion request may be a request for determining whether a user input received through the user input receiving module 420 is a shape or gesture previously stored at the memory 450.

According to various embodiments of the present disclosure, at least a portion of a low-power operation of the electronic device 400 may be retained in the active mode. For example, the amount of power consumed in the active mode is greater than that in the idle mode, but the active mode may be a state in which there is retained at least a portion of a function for operating in a low-power mode of which the power consumption is smaller than that of the normal mode. At this state, the processor 430 may determine whether the received user input is a pattern (e.g., a shape or a gesture) previously stored at the memory 450. For example, based on the user input, the processor 430 may operate in the low-power active mode up to an execution point in time of a specific application.

When the received user input is not a shape or a gesture stored at the memory 430, the processor 430 may change the low-power active mode again to the low-power idle mode. This may be to prevent power from being consumed when an active mode is retained even though a user does not touch the touch screen panel 500 on purpose to perform a certain operation.

According to various embodiments of the present disclosure, the electronic device 400 may receive a sound generated when the user input contacts with the touch screen panel 400, using a microphone (not illustrated) and may transmit the received sound to the processor 430. The processor 430 may determine whether the user input is valid, using the received sound. For example, a user may touch an area, which is set on the touch as a shape stored at the memory 450, with a nail by mistake. Alternatively, when the electronic device 400 exists in a pocket of a user, a key or a coin in the same pocket may touch the touch screen panel 500. In this case, the processor 430 may perform a certain operation even though a touch input is an erroneous touch input due to a nail, a key, a coin, or the like. Accordingly, validity on the user input may be determined using the microphone to prevent power from being consumed unnecessarily in such a case.

Determining whether to be a valid user input based on the sound generated by the user input may be set to be performed in the idle mode. In this case, since a role of the processor 430 is required, the determining may be set to be performed prior to determining whether the user input is a stored pattern, in the low-power active mode.

Similarly, the electronic device 400 may use a resistive sensor to determine whether the user input is a valid user input. The processor 430 may ignore the user input when a touch pressure of the user input is insufficient to such an extent as to touch with a finger.

According to various embodiments of the present disclosure, a shape or a gesture stored at the memory 450 may include touch down, touch release, long press, touch move from the touch down to the touch release, and the like on the touch screen panel 500. The touch movement may include operations, such as a swipe and the like. Furthermore, a shape or a gesture stored at the memory 450 may be a combination of at least two or more of the above-described touch down, touch release, long press, and touch move. For example, the stored shape or gesture may include transient hold (corresponding to the long press) during the touch move. Furthermore, the stored shape or gesture may include the touch down input several times or a multi-touch input.

According to various embodiments of the present disclosure, the processor 430 may determine whether the user input is a shape or gesture stored at the memory 450, based on at least one or more of a position, a time, a pressure, a contact area, and the number of touched fingers on the touch down, a position and a time on the touch release, a trajectory, a movement time, and a movement speed on the touch movement, or a stop time during the touch movement.

Even though the user input is not accurately consistent with the shape or gesture stored at the memory 450, the processor 430 may determine the user input to be valid considering an error range.

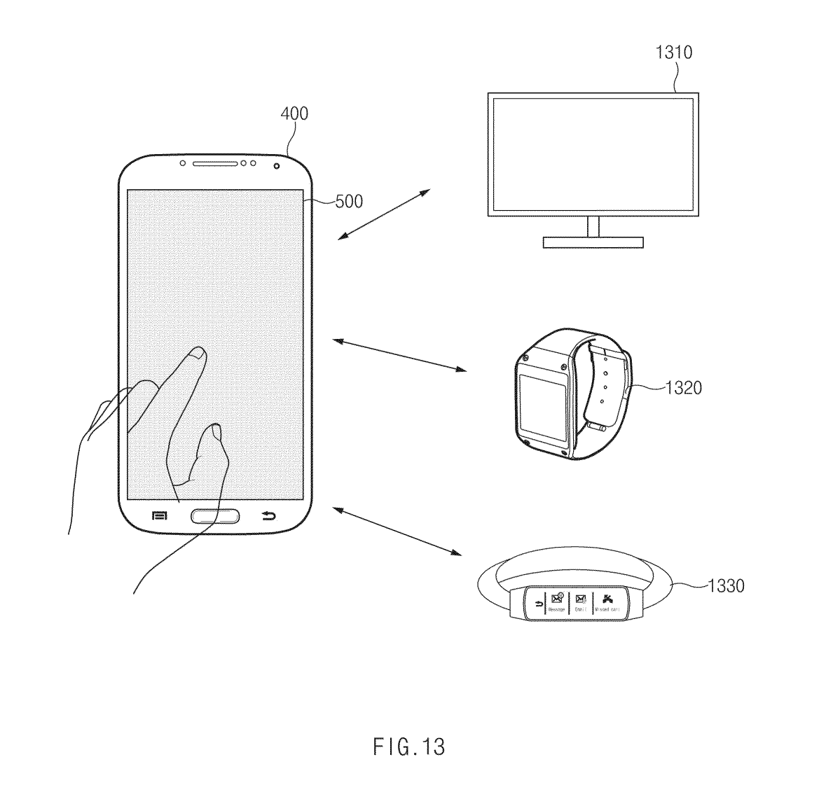

According to various embodiments of the present disclosure, the processor 430 may set an error range of each of an operation or a gesture to be different from each other using a learning algorithm. For example, in the case of an operation or gesture that a user frequently uses, the processor 430 may set an error range widely, thereby making it possible to determine a different but similar input as a user input. In this case, the processor 430 may utilize a user input, which a user inputs, and history information including an executed operation, an execution time, and the like. The processor 430 may set an error range of an operation or gesture to be different with respect to users. This will be more fully described together with a smart TV as an example of the electronic device 400 with reference to FIG. 13.

The communication module 440 may set communication between the electronic device 400 and an external device. For example, the communication module 440 may include a configuration that is at least the same as or similar to a communication interface 170 illustrated in FIG. 1. This will be more fully described with reference to FIG. 13.

The memory 450 may store data. The memory 450 may include a configuration that is at least the same as or similar to a memory 130 illustrated in FIG. 1. In this case, data stored at the memory 450 may include data exchanged between internal components of the electronic device 400 and data exchanged between the electronic device 400 and an external device. For example, the memory 450 may store information on a user input that the user input receiving module 420 receives. Furthermore, the memory 450 may store a user input that at least one or more users set as a shape or gesture. The memory 450 may be, for example, a hard disk drive, a ROM, a RAM, a flash memory, or a memory card that exists inside or outside the electronic device 400.

It may be comprehended to one skilled in the art that the touch screen module 410, the user input receiving module 420, the processor 430, the communication module 440, and the memory 450 are separate components or that one or more of the components 410 to 450 are integrated.

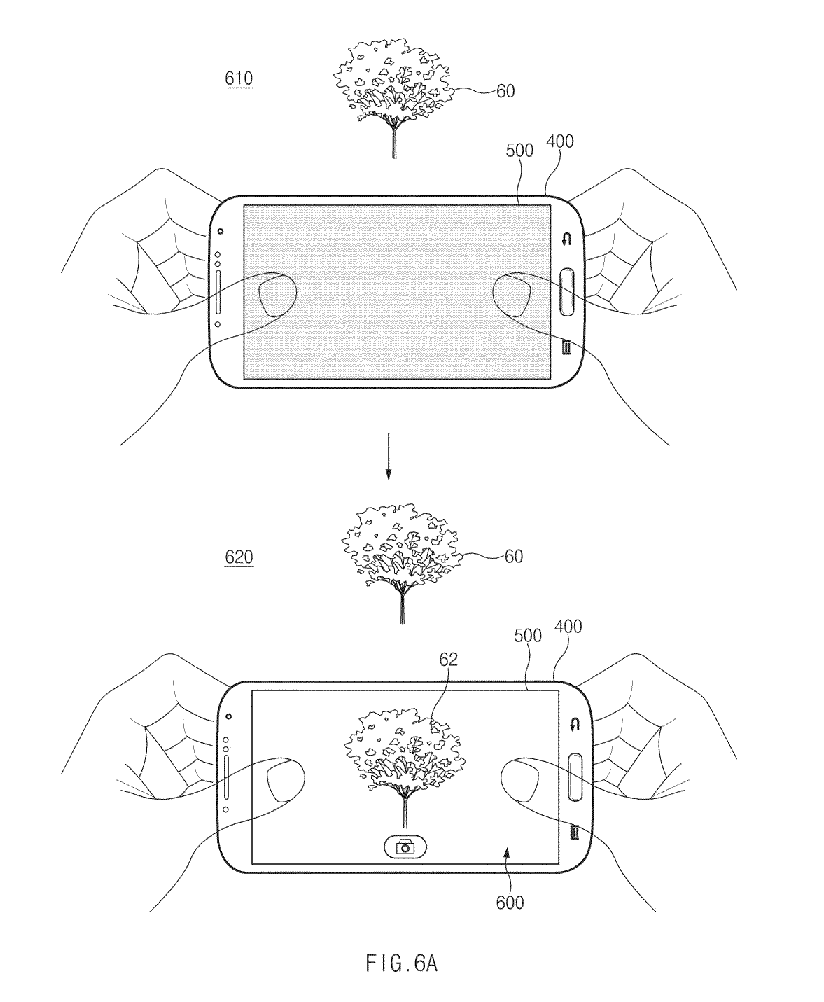

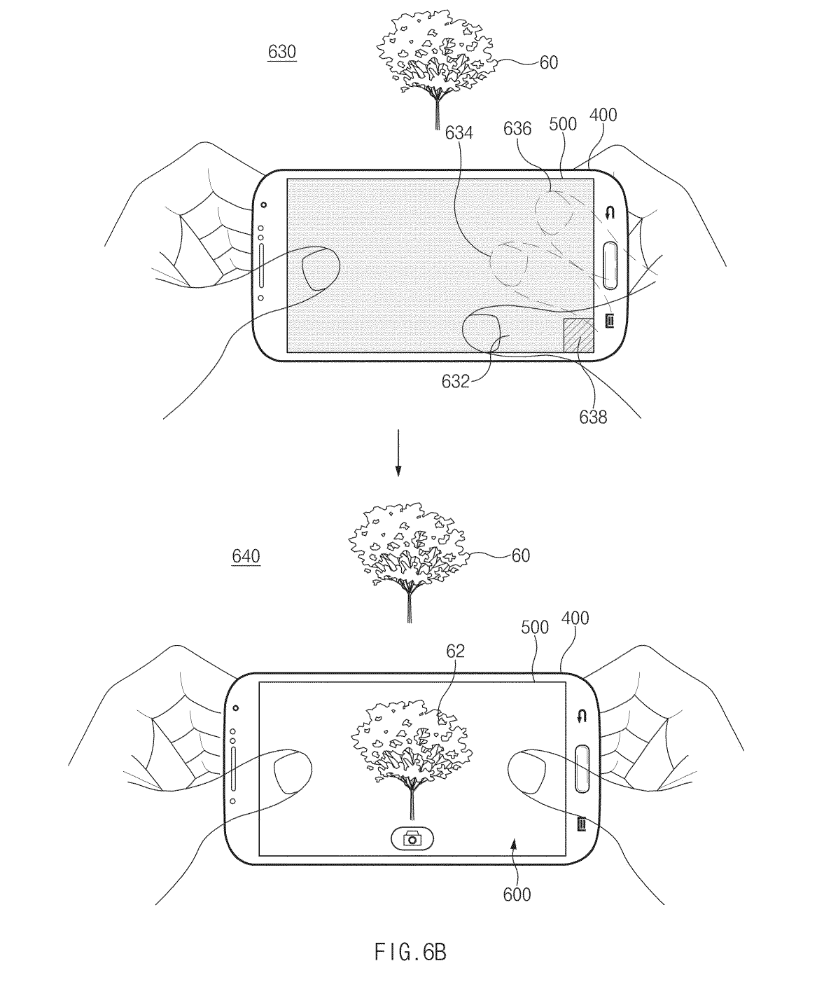

Below, operations of the electronic device 400 according to various embodiments of the present disclosure will be more fully described with reference to FIGS. 6A, 6B, 7, 8A, 8B, 9, 10, 11, 12, and 13.

According to various embodiments of the present disclosure, when the received user input is a shape or gesture stored at the memory 450, the processor 430 may execute a specific application as a certain operation corresponding to the user input.

FIG. 6A is a diagram illustrating execution of a camera application based on a certain shape according to various embodiments of the present disclosure. FIG. 6B is a diagram illustrating execution of a camera application based on a certain gesture according to various embodiments of the present disclosure.

Referring to FIG. 6A, in operation 610, a user may hold an electronic device 400 and may face the electronic device 400 toward a subject 60 to be taken, as illustrated in operation 610.

In operation 620, a processor 430 may execute a camera application 600 based on a user input as the shape. In this case, a display that remains at an off state in operation 610 may be turned on, and the camera application 600 may be displayed on a touch screen panel 500. Furthermore, the camera application 600 may provide a user with a preview image 62 of the subject 60.

Referring to FIG. 6B, operations 630 and 640 may be similar to those illustrated in FIG. 6A. In operation 630, at a state where the user holds the electronic device 400, as illustrated in operation 630, the user may move a thumb of the right hand such that the thumb moves to 636 from 632 through 634. An area 638 on a touch screen panel 500 may be an area in which a user input is ignored. The reason may be that when the user holds the electronic device with the right hand and moves the thumb as illustrated in operation 630, the bottom of the thumb contacts with an area 638 regardless of whether the thumb is placed at any of areas 632 to 636.

In operation 640, the processor 430 may execute the camera application 600 based on a user input as the gesture. Below, a description duplicated with operation 620 may be omitted.

In operations described with reference to FIGS. 6A and 6B, an operation for inputting a certain gesture may be more complicated than an operation for inputting a certain shape. For example, a certain gesture may be a set of certain shapes. Accordingly, a user may utilize a certain gesture to reduce an abnormal operation of the electronic device 400.

In a method of the related art, to execute a camera application, a user may push a power button of the electronic device 400, release a lock state, search for a camera application icon, and touch the camera application icon. When the camera application icon is not registered at favorites or exists at a back page of a plurality of application pages or in a folder, more procedures may be needed.

In contrast, according to the above-described embodiment of the present disclosure, a user may execute a camera application instantly by inputting a certain shape simply, thereby reducing a time taken to perform troublesome operations as compared with a method of the related art and improving user's convenience.

According to various embodiments of the present disclosure, it may be assumed the case that a moving or to-be-moved subject is captured, not the case that a standing subject 60 as illustrated in FIG. 6A is captured.

For example, a user may find a cat yawning on a wall. In this case, according to a method of the related art, the yawn of the cat to be captured may end while the user releases a lock state and turns over a page of an application UI. However, according to various embodiments of the present disclosure, to take a picture of a yawn scene of the cat, the user may execute a camera application quickly by facing an electronic device 400 toward the cat and inputting a certain shape or gesture. Alternatively, the user may put his/her hand in a pocket, may hold the electronic device therein to input a certain shape or gesture simultaneously such that a camera application is executed, and may face the electronic device 40 toward the cat to take a picture of a yawning appearance.

An operation in which based on a user input, the processor 430 turns on the display and executes an application is described with reference to FIGS. 6A and 6B. However, according to various embodiments of the present disclosure, the processor 430 may execute a certain operation, with all or a portion of the display turned off.

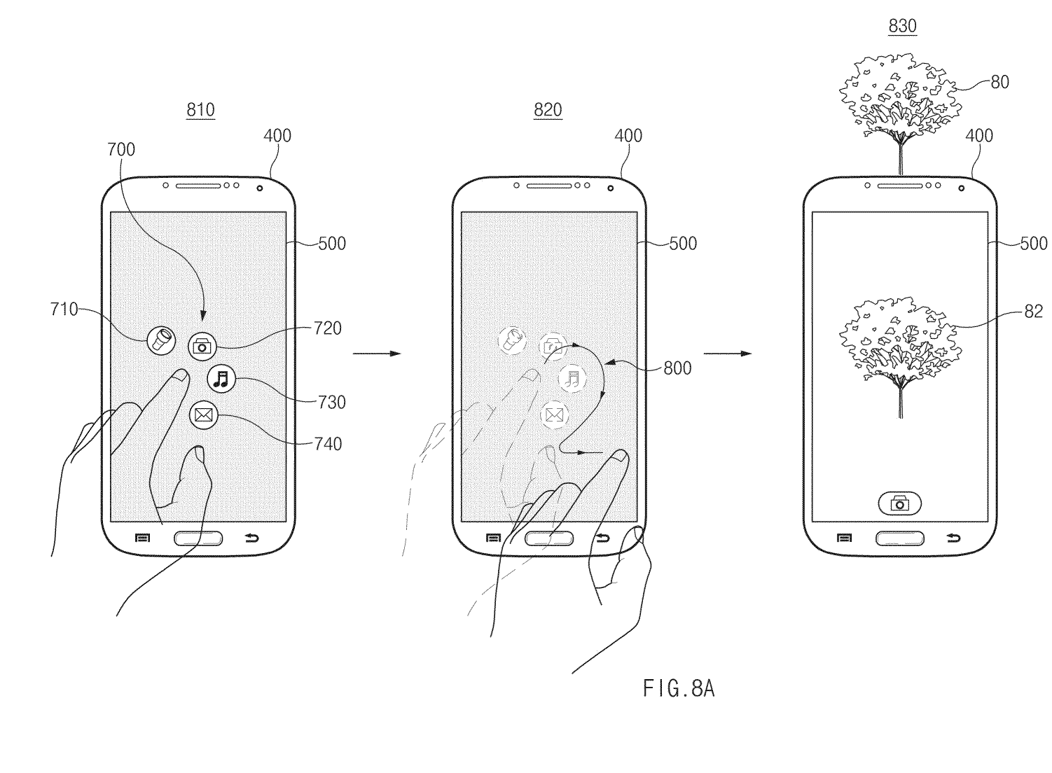

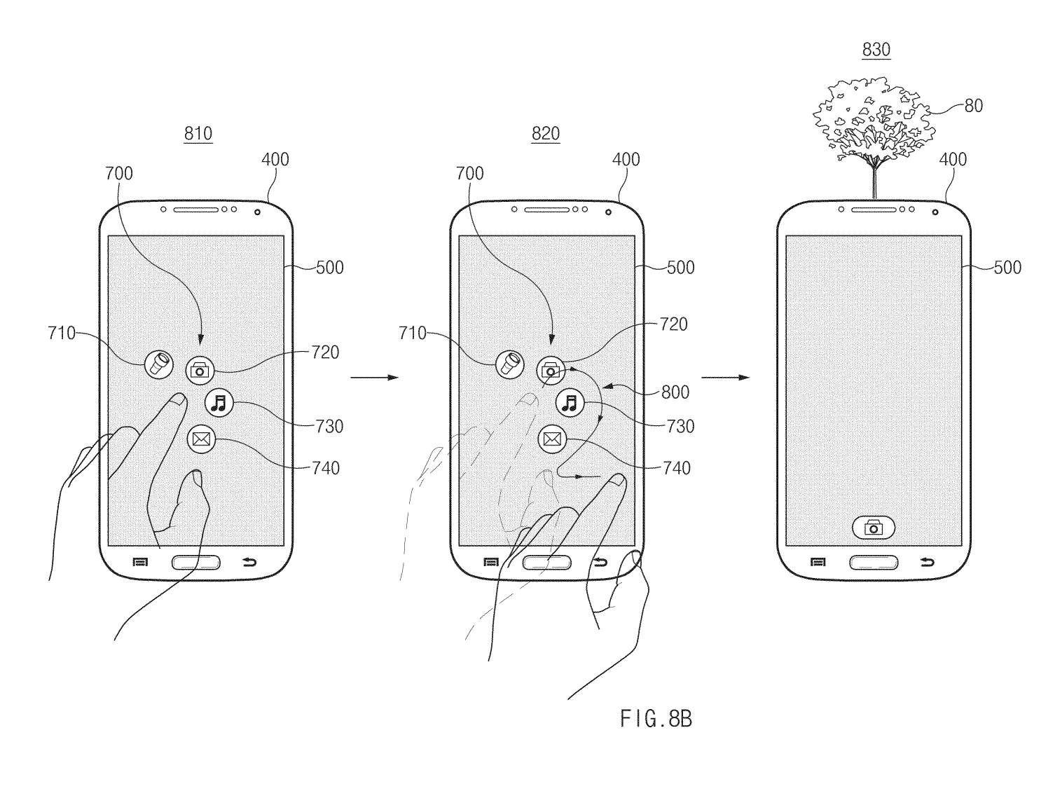

Below, there will be described a certain operation being performed, with the whole display turned off. The processor 430 may control a music application being executed at a background based on the user input. For example, as illustrated in FIGS. 8A and 8B, when a user input swiped upward at the touch screen panel 500 is received through the user input receiving module 420, the processor 430 may increase a volume of a music being played, with the whole display turned off. Furthermore, based on a user input swiped in a left direction or a right direction at the touch screen panel 500, the processor 430 may turn the music being played to a previous music or a next music, with the whole display turned off.

Similarly, when a user is on the telephone, with the whole display turned off, the processor 430 may increase a call volume based on a user input swiped upwards. Furthermore, based on a user input swiped in a left or right direction at the touch screen panel 500, the processor 430 may switch into a speaker phone form or a BT headset to output a voice output.

According to various embodiments of the present disclosure, when the received user input is a shape or gesture stored at the memory 450, the processor 430 may display an object on at least a portion, but not all of the touch screen panel 500. The object may include at least one of a menu icon corresponding to a favorites application list, a sub menu icon on one icon of the menu icon, notification on an application, an application execution screen, a setting menu for controlling a running application, or a setting menu for controlling a function of an electronic device. The object may be displayed at an area corresponding to an input received at the touch screen panel 500.

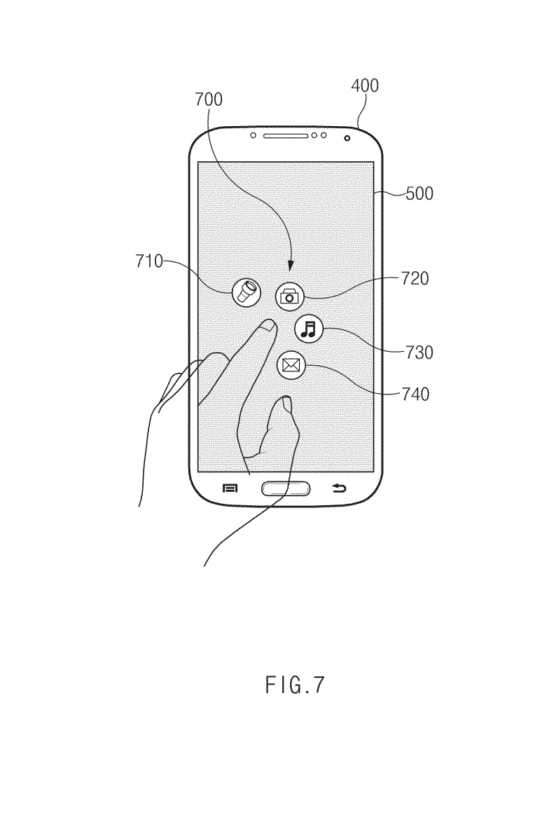

Below, a certain operation being performed at a state where a part of a display is turned off will be more fully described with reference to FIGS. 7, 8A, 8B, and 9.

FIG. 7 is a diagram illustrating an operation in which a menu icon is displayed based on a certain shape or gesture according to various embodiments of the present disclosure.

Referring to FIG. 7, when a user input received from a user corresponds to a certain shape or gesture, a processor 430 may display a menu icon 700 as an example of an object. For example, the certain shape or gesture may be long press on a specific position. Alternatively, the certain shape or gesture may be an operation in which long press occurs at a specific position after touch down is input at a bezel area and moves into the specific position.

According to various embodiments of the present disclosure, the object including the menu icon 700 may be displayed at an area corresponding to the received user input. For example, the object may be displayed at a position where the user input is long pressed or released. The display object may move as the user input moves. For example, when the user input moves in one direction at a touch down state, the object may be displayed in a movement direction of the user input and may be displayed in a direction opposite to the movement direction.

According to various embodiments of the present disclosure, a display of the touch screen panel 500 may remain at a turn-off state, and then a portion of the display may be turned on such that the menu icon 700 is displayed at a corresponding area. The touch screen module 410 may determine a position of a user's finger or palm, and the menu icon 700 may be displayed at an area on the touch screen panel 500 where the user's finger or palm is not placed.

Since a control is made by the pixel when the touch screen panel 500 is of an AMOLED manner, it may be easy to display the menu icon 700 solely. Otherwise, the processor 430 may overlay a dark image at the remaining portion other than the menu icon 700, thereby obtaining a screen illustrated in FIG. 7.

The menu icon 700 may include a flashlight application icon 710, a camera application icon 720, a music application icon 730, and an instant message application icon 740. The number or kinds of icons included in the menu icon 700 may be set by a user or automatically. For example, the menu icon may be displayed based on various conditions, such as an application which a user frequently uses, an application which the user recently uses, an application which the user sets, and the like.

According to various embodiments of the present disclosure, the processor 430 may receive a user input (e.g., touch down or long press) of a user for selecting one application icon included in the displayed menu icon 700 and may execute an application corresponding to the user input. Furthermore, based on a new user input of the user, the processor 430 may replace at least a portion of a plurality of application icons included in the displayed menu icon 700 with other application icon(s).

FIGS. 8A and 8B are diagrams illustrating a method for executing one icon of a displayed menu icon according to various embodiments of the present disclosure.

Referring to FIGS. 8A and 8B, operation 810 may correspond to an operation described with reference to FIG. 7, and a duplicated description thereof may be omitted.

In operation 820, a user input receiving module 420 may further receive a new user input 800 after the menu icon 700 is displayed. A trajectory of the new user input 800 may input a number “2” at the user input receiving module 420.

In operation 830, a processor 430 may execute a camera application icon 720, secondly placed, from among a plurality of application icons included in the displayed menu icon 700, based on the new user input 800. Accordingly, a camera application may be executed, and a subject 80 may be displayed as a preview image 82.

According to various embodiments of the present disclosure, the new user input 800 may be an alphabet, not a number. For example, numbers “1”, “2”, “3”, “4”, and the like may be replaced with letters of the alphabet ‘a”, “b”, “c”, “d”, and the like. As another example, each of application icons 710 to 740 may be selected by an initial letter thereof. A flashlight application icon 710 may be executed by an initial letter “L”, and a camera application icon 720 may be executed by an initial letter “C”. A music application icon 730 may be executed by an initial letter “M”, and an instant application icon 740 may be executed by an initial letter “I”.

The new user input 800 may be received newly after a touch on a user input in FIG. 7 is released. Alternatively, the new user input 800 may be a user input which is moved without touch release after the user input in FIG. 7 is long pressed. Alternatively, the new user input 800 may be input by a variation in a contact area of a user input in FIG. 7, a variation in the number of touched fingers, or a direction variation of touch movement.

According to various embodiments of the present disclosure, when the new user input 800 exists even though the menu icon 700 is not displayed, the processor 430 may perform a certain operation in the light of the menu icon 70 to be displayed.

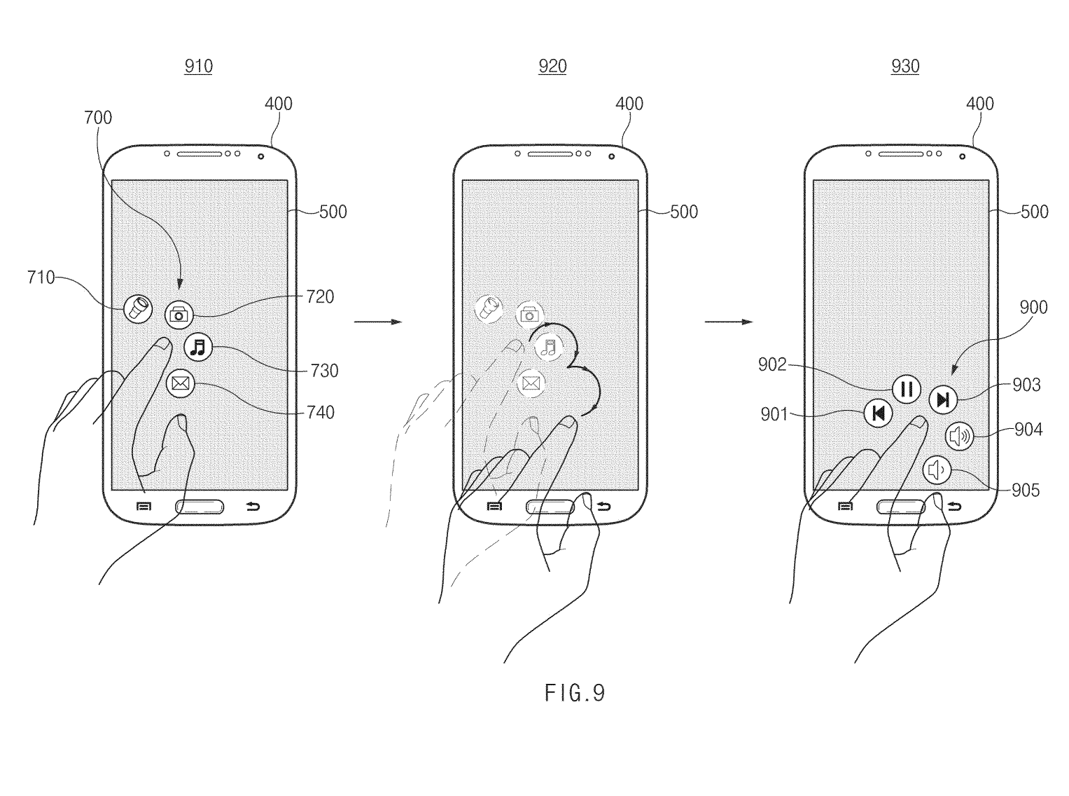

FIG. 9 is a diagram illustrating a method for displaying a sub menu icon on one icon of a displayed menu icon according to various embodiments of the present disclosure.

Referring to FIG. 9, operation 910 may correspond to that described with reference to FIG. 7, and a duplicated description thereof may be omitted.

In operation 920, a user input receiving module 420 may further receive a new user input after a menu icon 700 is displayed. A trajectory of the new user input may input a number “3” at the user input receiving module 420.

In operation 930, based on the new user input, a processor 430 may display a sub menu icon 900 on a music application icon 730, thirdly placed, from among a plurality of application icons included in the displayed menu icon 700.

The application icon 730 may be associated with a music application, and the sub menu icon 900 may include icons 910 to 905 for controlling the music application. In this case, a user may select one of the icons 901 to 905 for controlling the music application. Similarly to operation 920, the user may control the music application by inputting numbers “1” to “5” as a new user input.

For example, when an electronic device 400 is put in a pocket, the user may play music or stop music being played without taking out the electronic device 400 by sequentially inputting numbers “3” and “2” after inputting a long press in the pocket.

Furthermore, according to various embodiments of the present disclosure, operation 930 may be performed when the user performs long press on a music application icon 730 instead of inputting a number “3” in operation 920. Operation 930 may be performed when in operation 910, after the menu icon 700 is displayed, a touch is released, and touch down and long press are again performed with respect to the music application icon 730 as well as when in operation 910, the music application icon 730 is long pressed without touch release after the menu icon 700 is displayed.

Similarly, when in operation 920, a user inputs a number “2” or long press on a camera application icon 720, a sub menu icon of the camera application icon 720 may be displayed. In this case, the sub menu icon of the camera application icon 720 may be a shooting mode (a selfie mode) using a front camera, a shooting mode using a rear camera, a captured image display mode, or the like.

When in operation 920, a user inputs a number “4” or long press on an instant message application icon 740, a “message view” icon, a “message input” icon, and the like may be displayed as the sub menu icon of the instant message application icon 740.

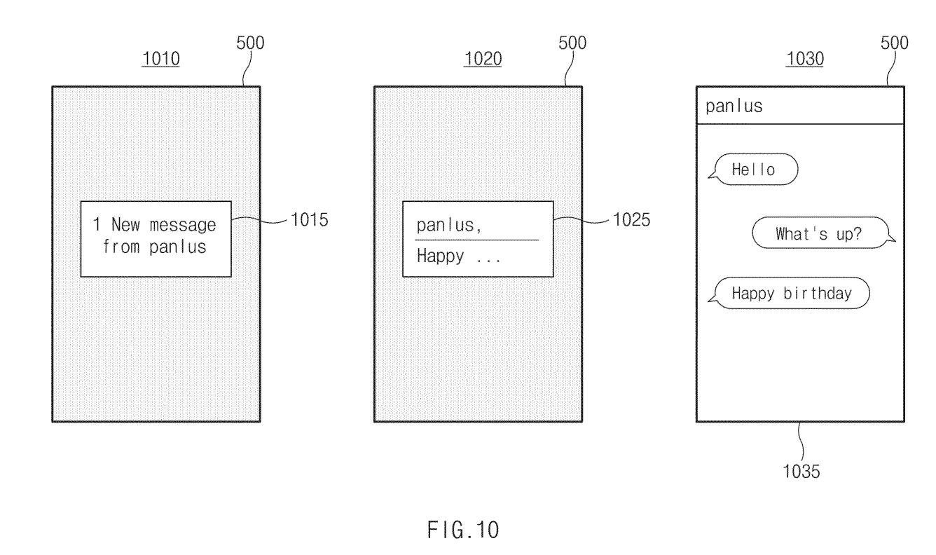

FIG. 10 is a diagram illustrating various methods for performing an operation corresponding to an instant message application according to various embodiments of the present disclosure.

Referring to FIG. 10, in a first embodiment 1010, the processor 430 may provide simple information 1015 on an instant message application. The simple information 1015 may provide the number of new messages or whether a new message is received.

Referring to a second embodiment 1020, the processor 430 may provide partial information on the instant message application. The partial information 1025 may provide a portion of a message's content and caller information. When the new message is in plurality, the partial information 1025 may include a portion of a message's content and caller information on each of the plurality of messages. In this case, the partial information 1025 may show all of pieces of information, or may show the pieces of information by the segmentation using a scroll manner.

Referring to a third embodiment 1030, the processor 430 may execute an instant message application 1035. When a new message is in plurality, the executed instant message application 1035 may display a firstly received message or the most recently received message.

According to various embodiments of the present disclosure, the three embodiments 1010, 1020, and 1030 may be independent of each other or may be associated with each other. For example, a user may independently set a user input corresponding to the embodiment 1010, a user input corresponding to the embodiment 1020, and a user input corresponding to the embodiment 1030 in an idle mode or a low-power active mode. As another example, at a display point in time of partial information 1015, the processor 430 may display the partial information 1025 based on a first additional user input and may display an instant message application 1035 based on a second additional user input. At a display point in time of the partial information 1015, the processor 430 may display the instant message application 1035 based on a third additional user input. The first to third additional user inputs may be the same input or different inputs.

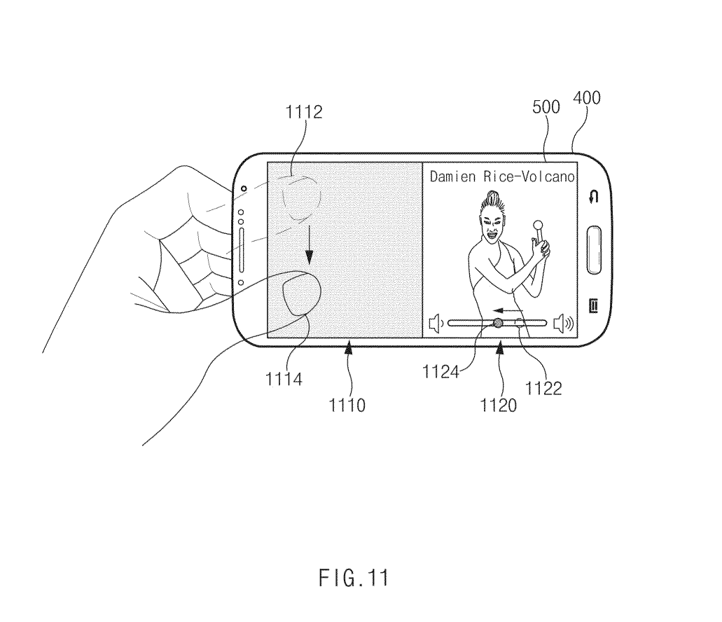

FIG. 11 is a diagram illustrating a method for executing, in a dual screen mode, a certain operation based on a user input according to various embodiments of the present disclosure.

Referring to FIG. 11, an electronic device 400 may use a touch screen panel 500 that is divided into a first screen area 1110 and a second screen area 1120.

A user input receiving module 420 may receive a user input through the first screen area 1110. In this case, a display of the first screen area 1110 may remain at an off state.

According to various embodiments of the present disclosure, when the user input is a shape or gesture stored at a memory 450, a processor 4300 may execute a certain operation corresponding to the user input at the second screen area 1120.

When the certain operation is an operation for executing an application, for example, the electronic device 400 may execute the application at the second screen area 1120, with the display of the first screen area 1110 turned off. When a display of the second screen area 1120 remains at an off state, the processor 430 may turn on the display of the second screen area and may then execute the application. Furthermore, when another application is displayed at the second screen area 1120, the processor 430 may execute an application, corresponding to a certain operation, on the displayed application.

When the certain operation is an operation for controlling an application running at the second screen area 1120, the processor 430 may operate as follows. Referring to FIG. 11, when a user's finger moves from an area 1112 of the first screen area 1110 to an area 1114 thereof, a user input receiving module 420 may receive a downward swipe as a user input. With regard to a music application running, the processor 430 may move a volume indicator from an area 1122 to an area 1124 based on the user input.

According to various embodiments of the present disclosure, even though the electronic device 400 does not use a dual screen mode, an operation illustrated in FIG. 11 may display an execution screen of an application at the second screen area as a portion of the touch screen panel 500 or may perform a control operation on an executed application.

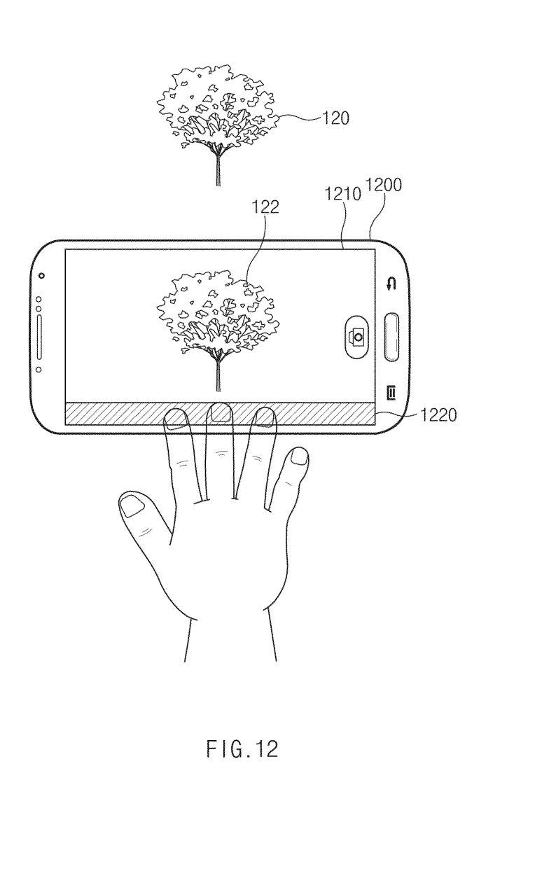

FIG. 12 is a diagram illustrating a method in which an electronic device including a plurality of touch screen panels performs a certain operation based on a user input according to various embodiments of the present disclosure.

Referring to FIG. 12, an electronic device 1200 may include a first touch screen panel 1210 and a second touch screen panel 1220. In a dual screen mode described with reference to FIG. 11, one touch screen panel 500 may be divided into two areas. However, the electronic device 1200 illustrated in FIG. 12 may use different touch screen panels. Accordingly, the electronic device 1200 may include a touch screen module by the touch screen panel, and touch screen panels of the electronic device 1200 may be controlled independently of each other.

Referring to FIG. 12, a first touch screen panel 1210 and a second touch screen panel 1220 may be illustrated as being placed at the front side of the electronic device 1200. However, according to various embodiments of the present disclosure, the different touch screen panels 1210 and 1220 may be positioned at the same surface or at difference surfaces. For example, the first touch screen panel 1210 may be positioned at the front surface of the electronic device 1200, and the second touch screen panel 1220 may be positioned at the rear surface of the electronic device 1200. Alternatively, the first touch screen panel 1210 may be positioned at the front surface of the electronic device 1200, and the second touch screen panel 1220 may be positioned at the side surface of the electronic device 1200.

According to various embodiments of the present disclosure, referring to FIG. 12, a camera application may be executed on the first touch screen panel 1210 of the electronic device 1200 and a subject 120 may be displayed as a preview image 122. In this case, a user may input a multi-touch on the second touch screen panel 1220 of which the display is turned off.

For example, a user input receiving module 420 may receive the multi-touch input on the second touch screen panel 1220 as a user input. When the user input is a certain shape or operation stored at a memory 450, the processor 430 may perform a certain operation corresponding to the user input, with the display of the second touch screen panel 1220 turned off Since the camera application is running at the first touch screen panel 1210, the user input may be the following operation corresponding to the camera application: still shot shooting, video mode change, selfie mode change, zoom in/output, album view, or the like.

According to various embodiments of the present disclosure, the processor 430 may execute a new application, which corresponds to the user input, on the camera application running at the first touch screen panel 1210, based on the user input. In this case, also, the display of the second touch screen panel 1220 may remain at an off state.

FIG. 13 is a diagram illustrating a relationship between an electronic device and other electronic devices according to various embodiments of the present disclosure.

Referring to FIG. 13, an electronic device 400 may be paired or coupled with a TV 1310, a first wearable device 1320, or a second wearable device 1330 through a network. According to various embodiments of the present disclosure, the electronic device 400 may be paired or coupled with one of the TV 1310, the first wearable device 1320, or the second wearable device 1330 in the one-to-one fashion. However, the scope and spirit of the present disclosure may not be limited thereto. For example, the electronic device 400 may be paired or coupled with one of the TV 1310, the first wearable device 1320, or the second wearable device 1330 in the one-to-M fashion (M being an integer of 2 or more) or in the M-to-N fashion (N being an integer of 2 or more). The pairing or coupling through the network may be made at a communication module 440. The network may mean a connection structure capable of exchanging information between nodes, such as terminals and servers, and may include a wireless LAN, a WAN, a personal area network (PAN), 3rd generation (3G), LTE, Wi-Fi, world interoperability for microwave access (WiMAX), wireless gigabit (WiGig), and the like.

According to various embodiments of the present disclosure, when a user input received by the user input receiving module 420 is a shape or gesture stored at the memory 450, the processor 430 may generate a message for requesting another electronic device 1310, 1320, or 1330, connected to the network, to perform a certain operation corresponding to the user input. The request message may be transmitted to the electronic device 1310, 1320, or 1330 through the communication module 440.

Referring to FIGS. 6A, 6B, 7, 8A, 8B, 9, 10, 11, 12, and 13, the electronic device 400 may be illustrated as being a portable electronic device. However, as described above, the electronic device 400 may be diverse. When the portable electronic device is a personal electronic device, various embodiments on a smart TV as a home common electronic device will be described.

Different shapes or gestures may be stored at a memory 450 of a smart TV, which home users utilize, by the user. A certain operation that corresponds to a user input and is variable according to a user may be stored at the memory 450 of the smart TV. For example, a channel that a user prefers to may be set by the user, and a corresponding channel may be displayed on a screen when power is turned on according to a specific gesture.

According to various embodiments of the present disclosure, when a user input receiving module 420 receives a user input, the processor 430 may determine whether the user input is associated with any user. For example, the processor 430 may determine a user (or perform user authentication) using a fingerprint shape, a variation in a current detected at a touch sensor, or a voltage decrease level in the user input. Alternatively, the processor 430 may determine a user through face recognition, iris recognition, and the like that are performed using a camera module (e.g., a front camera) of the smart TV.

Furthermore, many users may in common use a shape(s) or gesture(s) basically stored at the memory 450. Since a hand size, a hand vibration degree, and an area, a size, a length, a radius of a finger are different every user, the processor 430 may perform comparison between a user input and a stored shape or gesture so as to be differently applied according to a user.

Similarly, the processor 430 may set an error range so as to be changed according to a user. For example, when a user is a child or the aged, the processor 430 may set an error range widely, and when a user is a teenager or young people, the processor 430 may set an error range narrowly.

An electronic device according to various embodiments of the present disclosure may include a touch screen module including at least one touch sensor and a display screen, a memory, at least one processor electrically connected to the touch screen module and the memory. In this case, the touch screen module may have at least one of a first state in which no input is received through the touch sensor and no display screen operates, a second state in which an input is received using at least a portion of the touch sensor and no display screen operates, or a third state in which all of the touch sensor and all of the display screen operate. The second state may switch to a fourth state in which a portion, but not all of the display screen is displayed, in response to an input received using at least a portion of the touch sensor at the second state.

According to various embodiments of the present disclosure, the touch screen module may receive an input using a low-power self-capacitance type of touch screen panel at the second state.

According to various embodiments of the present disclosure, the touch screen module may receive an input using at least a portion of a plurality of Rx lines or a plurality of Tx lines of the touch screen panel at the second state. More particularly, the touch screen module may receive an input using an Rx line set, including all or a portion of the plurality of Rx lines, or a Tx line set, including all or a portion of the plurality of Tx lines, at the second state.

According to various embodiments of the present disclosure, switching from the second state to the fourth state may be performed at the processor when the received input is a pattern stored at the memory. The pattern stored at the memory may include, for example, a shape or a gesture.

According to various embodiments of the present disclosure, the stored pattern may include touch down, touch release, long press, swipe, touch move, and hold during the touch move on the touch screen panel. In this case, whether the received input is a pattern stored at the memory of the electronic device may be determined based on at least one or more of a position, a time, a pressure, a contact area, and the number of touched fingers on the touch down, a position and a time on the touch release, a trajectory, a movement time, and a movement speed on the touch movement, or a stop time during the touch movement.

According to various embodiments of the present disclosure, a pattern stored at the memory and an operation to be performed according to the fourth state may be set to be different every user.

According to various embodiments of the present disclosure, the processor may determine a user using a fingerprint shape obtained from the received input, a variation in a current detected at a touch sensor, or a voltage decrease level.

According to various embodiments of the present disclosure, an object may be displayed on at least a portion, but not all of the display screen at the fourth state. In this case, the object may include, for example, at least one of a menu icon corresponding to a favorites application list, a sub menu icon on one icon of the menu icon, notification on an application, an application execution screen, a setting menu for controlling a running application, or a setting menu for controlling a function of an electronic device. The object may be displayed at an area corresponding to an input received at the touch screen panel 500. In this case, the object may be displayed at an area where no finger or palm of a user is placed on the display screen.

The display screen according to various embodiments of the present disclosure may include a first display area and a second display area as a portion of the display screen. The first display area may operate at the second state, and the second display area may display the object based on an input on the first display area.

The electronic device according to various embodiments of the present disclosure may include a first touch screen panel and a second touch screen panel. The first touch screen panel may operate at the second state, and the second touch screen panel may operate at the third state or at the fourth state.

According to various embodiments of the present disclosure, the electronic device may further include a microphone configured to receive a sound generated when the input is touched at a touch screen panel. The processor may determine validity on the received input using the sound received through the microphone when the input is touched.

According to various embodiments of the present disclosure, the touch screen module may further receive a new input using at least a portion of the touch sensor after the menu icon is displayed. In this case, the processor may perform at least one or more of displaying a sub menu icon on one icon of the display menu icon, an operation corresponding to the one icon, or displaying at least a portion of the displayed menu icon as a new menu icon, based on the received new input.

According to various embodiments of the present disclosure, the processor may adjust at least one or more of a response time of a touch screen panel, a reference determining time, a core operation of a noise filter, a voltage level of an Rx line or a Tx line, or an IC clock at the second state through the touch screen module.

An electronic device according to various embodiments of the present disclosure may include a touch screen module including at least one touch sensor and a display screen, a memory, at least one processor electrically connected to the touch screen module and the memory. In this case, the touch screen module may have at least one of a first state in which no input is received through the touch sensor and no display screen operates, a second state in which an input is received using at least a portion of the touch sensor and no display screen operates, or a third state in which all of the touch sensor and all of the display screen operate. The touch screen module may retain the second state or switch the second state to the third state, in response to an input received using at least a portion of the touch sensor at the second state.

According to various embodiments of the present disclosure, the second state may include an operation in which an application is executed at a background. The retaining of the second state may be to control an application executed at the background in response to an input received using at least a portion of the touch sensor at the second state.

The electronic device according to various embodiments of the present disclosure may further include a communication module configured to pair or couple the electronic device with another electronic device. The communication module may control a function of at least a portion of another electronic device in response to an input received using at least a portion of the touch sensor at the second state.

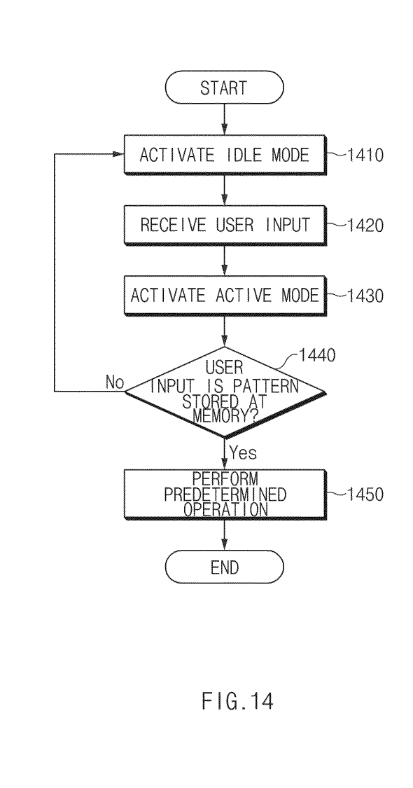

FIG. 14 is a flowchart illustrating a method for receiving a user input using an idle mode according to various embodiments of the present disclosure.

Referring to FIG. 14, a method for receiving a user input using an idle mode may include operations that an electronic device 400 according to an embodiment of the present disclosure illustrated in FIGS. 1 to 13 processes in time series. Accordingly, even though contents are omitted below, contents described with regard to the electronic device in FIGS. 1 to 13 may be applied to the method for receiving a user input using an idle mode according to an embodiment illustrated in FIG. 14.

In operation 1410, the electronic device 400 may activate an idle mode. The idle mode may be a mode in which a user input is detected, with a display of a touch screen panel 500 turned off.

In operation 1420, in the idle mode activated in operation 1410, the electronic device 400 may receive a user input through a touch screen panel 500, with a display turned off.

In operation 1430, the electronic device 400 may activate an active mode in response to a user input received in operation 1420. For example, as a user input received in operation 1420 is triggered, the electronic device 400 may switch the idle mode activated in operation 1410 to an active mode. The active mode may be a low-power active mode for reducing current consumption.

In operation 1440, the electronic device 400 may determine whether a user input received in operation 1420 is a shape or gesture stored at a memory 450. The method may proceed to operation 1410 as a consequence of determining that the user input is not a shape or gesture stored at the memory 450.

When the user input is a shape or gesture stored at the memory 450, in operation 1450, the electronic device 400 may perform a certain operation corresponding to the user input.

According to various embodiments of the present disclosure, a method in which an electronic device receives an input using at least a portion of a touch sensor may include operating a touch screen module at a second state among states of a touch screen module including a first state in which no input is received through the touch sensor and no display screen operates, a second state in which an input is received using at least a portion of the touch sensor and no display screen operates, or a third state in which all of the touch sensor and all of the display screen operate, receiving an input using at least a portion of the touch sensor at the second state, and switching the second state to a fourth state in which a portion, but not all of the display screen is displayed, in response to the input.

According to various embodiments of the present disclosure, the receiving of an input at the second state may be performed using a low-power self-capacitance type of touch screen panel. Furthermore, according to various embodiments of the present disclosure, the receiving of an input at the second state may be performed using at least a part of a plurality of Rx lines or a plurality of Tx lines of a touch screen panel.

According to various embodiments of the present disclosure, the method may further include displaying an object on a portion, but not all of the display screen at the fourth state. The object may be displayed at an area corresponding to the received input. The object according to various embodiments of the present disclosure may include at least one of a menu icon corresponding to a favorites application list, a sub menu icon on one of the menu icon, notification on an application, an application execution screen, a setting menu for controlling a running application, or a setting menu for controlling a function of an electronic device.

According to various embodiments of the present disclosure, a computer recording medium storing an instruction, the instruction, when executed by at least one processor, causing the at least one processor to perform operating a touch screen module at a second state among states of a touch screen module including a first state in which no input is received through the touch sensor and no display screen operates, a second state in which an input is received using at least a portion of the touch sensor and no display screen operates, or a third state in which all of the touch sensor and all of the display screen operate, receiving an input using at least a portion of the touch sensor at the second state, and switching the second state to a fourth state in which a portion, but not all of the display screen is displayed, in response to the input at the second state.

The term “module” used herein may represent, for example, a unit including one or more combinations of hardware, software and firmware. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” according to various embodiments of the present disclosure may include at least one of an application-specific IC (ASIC) chip, a field-programmable gate array (FPGA), and a programmable-logic device for performing some operations, which are known or will be developed.

According to various embodiments of the present disclosure, at least a portion of an apparatus (e.g., modules or functions thereof) or a method (e.g., operations) according to various embodiments of the present disclosure, for example, may be implemented by instructions stored in a computer-readable storage media in the form of a programmable module. The instruction, when executed by one or more processors (e.g., the processor 120), may cause the one or more processors to perform a function corresponding to the instruction. The computer-readable storage media, for example, may be the memory 130.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a Read-Only Memory (ROM), a Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

A module or a programming module according to an embodiment of the present disclosure may include at least one of the above elements, or a portion of the above elements may be omitted, or additional other elements may be further included. Operations performed by a module, a programming module, or other elements according to an embodiment of the present disclosure may be executed sequentially, in parallel, repeatedly, or in a heuristic method. In addition, a portion of operations may be executed in different sequences, omitted, or other operations may be added.

An electronic device and a method according to various embodiments of the present disclosure may receive a user input in an idle mode of a low power state and may perform a certain operation based on the received user input, thereby reducing power consumption.

Furthermore, the electronic device and the method according to various embodiments of the present disclosure may input a certain pattern at a touch screen panel at a lock state of the electronic device, thereby making it possible to perform a specific application or a specific function quickly.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a touch screen module including at least one touch sensor and a display screen;
a memory; and
at least one processor electrically connected to the touch screen module and the memory,
wherein the touch screen module operates in at least one of:
a first state in which no input is received through the at least one touch sensor and no display screen operates,
a second state in which an input is received using at least a portion of the at least one touch sensor and no display screen operates, or
a third state in which all of the at least one touch sensor and all of the display screen operate, and
wherein the second state is switched to a fourth state in which a portion, but not all of the display screen is displayed, in response to a user input received using at least a portion of the at least one touch sensor on the second state.

2. The electronic device of claim 1, wherein the touch screen module operating on the second state is configured to receive a user input using a low-power self-capacitance type of touch screen panel.

3. The electronic device of claim 1, wherein the touch screen module operating on the second state is configured to receive at least one of:
a user input using at least a part of a plurality of Rx lines or a plurality of Tx lines of the touch screen panel;
a user input using an Rx line set including all or a part of the plurality of Rx lines; or
a user input using a Tx line set including all or a part of the plurality of Tx lines.

4. The electronic device of claim 1, wherein the switching from the second state to the fourth state is performed by the at least one processor, if the received user input is a pattern including at least one of a shape or a gesture stored at the memory.

5. The electronic device of claim 1,
wherein an object is displayed on at least a portion, but not all of the display screen on the fourth state, and
wherein the object is displayed at an area corresponding to a position of the received user input.

6. The electronic device of claim 5, wherein the object comprises at least one of a menu icon corresponding to a favorites application list, a sub menu icon on one of the menu icon, notification on an application, an application execution screen, a setting menu for controlling a running application, or a setting menu for controlling a function of the electronic device.

7. The electronic device of claim 5,
wherein the display screen comprises a first display area and a second display area as a portion of the display screen,
wherein the first display area operates on the second state, and
wherein the object is displayed on the second display area based on a user input provided onto the first display area.

8. The electronic device of claim 1,
wherein the electronic device further comprises a first touch screen panel and a second touch screen panel,
wherein the first touch screen panel operates on the second state, and
wherein the second touch screen panel operates on the third state or on the fourth state.

9. The electronic device of claim 1, further comprising:
a microphone configured to receive a sound generated when the user input is provided onto a touch screen panel,
wherein the at least one processor is configured to determine validity on the received input using the touching sound received through the microphone when the user input is provided.

10. The electronic device of claim 4, wherein a pattern stored at the memory and an operation to be performed according to the fourth state are set to be different by the user account.

11. The electronic device of claim 10, wherein the at least one processor is configured to determine a user using a fingerprint shape obtained from the received user input, a variation in a current detected at the at least one touch sensor, or a voltage decrease level.

12. The electronic device of claim 6,
wherein the touch screen module is configured to further receive a new user input using at least a portion of the at least one touch sensor after the menu icon is displayed,
wherein, based on the received new user input, the at least one processor is configured to:
display a sub menu icon on one icon of the displayed menu icon,
perform an operation corresponding to the one icon, or
display at least a portion of the displayed menu icon as a new menu icon.

13. The electronic device of claim 1, wherein the at least one processor is configured to adjust at least one or more of a response time of a touch screen panel, a reference determining time, a core operation of a noise filter, a voltage level of an Rx line or a Tx line, or an IC clock on the second state through the touch screen module.

14. An electronic device comprising:
a touch screen module including at least one touch sensor and a display screen;
a memory; and
at least one processor electrically connected to the touch screen module and the memory,
wherein the touch screen module comprises one of:
a first state in which no input is received through the at least one touch sensor and no display screen operates,
a second state in which an input is received using at least a portion of the at least one sensor and no display screen operates, or
a third state in which all of the at least one touch sensor and all of the display screen operate, and
wherein the touch screen module retains the second state or switches the second state to the third state, in response to a user input received using at least a portion of the at least one touch sensor on the second state.

15. The electronic device of claim 14,
wherein the second state comprises an operation in which an application is executed on a background, and
wherein the retaining of the second state is to control an application executed on the background in response to a user input received using at least a portion of the at least one touch sensor on the second state.

16. The electronic device of claim 14, further comprising:
a communication module configured to:
pair or couple the electronic device with another electronic device, and
control a function of at least a portion of the another electronic device in response to a user input received using at least a portion of the at least one touch sensor on the second state.

17. A method in which an electronic device receives an input using at least a portion of a touch sensor, the method comprising:
operating a touch screen module on a second state among states of a touch screen module including a first state in which no input is received through the touch sensor and no display screen operates, the second state in which an input is received using at least a portion of the touch sensor and no display screen operates, or a third state in which all of the touch sensor and all of the display screen operate;
receiving a user input using at least a portion of the touch sensor on the second state; and
switching the second state to a fourth state in which a portion, but not all of the display screen is displayed, in response to the user input.

18. The method of claim 17, wherein the receiving of a user input on the second state is performed using a low-power self-capacitance type of touch screen panel.

19. The method of claim 17, wherein the receiving of a user input on the second state is performed using at least a portion of a plurality of Rx lines or a plurality of Tx lines of a touch screen panel.

20. The method of claim 17, further comprising:
displaying an object on a portion, but not all of the display screen on the fourth state,
wherein the object is displayed on an area corresponding to the received user input.
